(19) United States
(12) Patent Application Publication
(10) Pub. No.: US 2024/0303591 A1
(43) Pub. Date: Sep. 12, 2024

(54) CREATION METHOD, INFORMATION PROCESSING METHOD, STORAGE METHOD, ELECTRONIC DEVICE, AND STORAGE MEDIUM

(71) Applicants: BEIJING ZHONGXIANGYING TECHNOLOGY CO., LTD., Beijing (CN); BOE TECHNOLOGY GROUP CO., LTD., Beijing (CN)

(72) Inventors: Yuanyuan Lu, Beijing (CN); Dong Chai, Beijing (CN); Hong Wang, Beijing (CN); Nan Liu, Beijing (CN)

(21) Appl. No.: 17/757,999

(22) PCT Filed: Aug. 20, 2021
(86) PCT No.: PCT/CN2021/113874

§ 371 Date: Jun. 24, 2022

(51) Int. Cl. G06Q 10/087

(52) U.S. Cl. CPC G06Q 10/087; G06Q 2220/00

(57) ABSTRACT

The present disclosure provides a creation method, an information processing method, a storage method, an electronic device and a storage medium. The creation method includes: acquiring a creation request for creating the supply chain management system, wherein the creation request contains a business information related to creating the supply chain management system; and creating the supply chain management system according to the business information and a blockchain basic architecture, in response to the creation request, wherein, the blockchain basic architecture includes an interface layer, a management layer, a core layer and a base layer, the supply chain management system includes a main chain system and a plurality of parallel chain systems connected to the main chain system, each of the parallel chain systems corresponds to a business scenario, and an information sharing between the plurality of parallel chain systems is achieved based on the main chain system.

CROSS REFERENCE TO RELATED APPLICATION(S)

This application is the national phase of PCT application No. PCT/CN2021/113874 filed on Aug. 20, 2021, the contents of which are incorporated herein by reference in their entirety.

### TECHNICAL FIELD

The present disclosure relates to a field of a blockchain and supply chain technology, in particular to a creation method, an information processing method, a storage method, an electronic device and a storage medium.

### BACKGROUND

A supply chain refers to a functional network chain structure that integrates a supplier, a manufacturer, a transporter, a retailer and a customer by centering on a core enterprise, starting with a supporting part, making an intermediate product and a final product, and finally delivering a product to the customer through a sales network.

A supply chain management refers to a management mode of planning, coordinating, operating, controlling and optimizing an entire supply chain system, which aims to reduce supply chain costs and promote an information flow and a value exchange by integrating enterprises from the supplier to the retailer on the supply chain, so as to improve an operational efficiency of the supply chain.

### SUMMARY

In view of this, the present disclosure provides a creation method, an information processing method, a storage method, an electronic device and a storage medium.

An aspect of the present disclosure provides a method of creating a blockchain-based supply chain management system, including: acquiring a creation request for creating the supply chain management system, wherein the creation request contains a business information related to creating the supply chain management system; and creating the supply chain management system according to the business information and a blockchain basic architecture, in response to the creation request, wherein, the blockchain basic architecture includes an interface layer, a management layer, a core layer and a base layer, the supply chain management system includes a main chain system and a plurality of parallel chain systems connected to the main chain system, each of the parallel chain systems corresponds to a business scenario, and an information sharing between the plurality of parallel chain systems is implemented based on the main chain system.

Another aspect of the present disclosure provides a method of processing an information, applied to a supply chain management system, wherein the supply chain management system includes a main chain system and a plurality of parallel chain systems connected to the main chain system, each of the parallel chain systems corresponds to a business scenario, and an information sharing between the plurality of parallel chain systems is implemented based on the main chain system; and the method includes: verifying, in response to an authority verification request, a user information contained in the authority verification request, wherein the authority verification request requests to verify whether a user corresponding to the user information has an information query authority or not; acquiring an information query request in response to a verification result of the user corresponding to the user information having the information query authority, wherein the information query request contains an information identification; determining, in response to the information query request, a blockchain storing a transaction information corresponding to the information identification, wherein the blockchain includes at least one of a main chain blockchain of the main chain system and a parallel chain blockchain of the parallel chain systems; and acquiring the transaction information from the blockchain storing the transaction information corresponding to the information identification.

Another aspect of the present disclosure provides a method of storing an information, applied to a supply chain management system, wherein the supply chain management system includes a main chain system and a plurality of parallel chain systems connected to the main chain system, each of the parallel chain systems corresponds to a business scenario, and an information sharing between the plurality of parallel chain systems is implemented based on the main chain system; and the method includes: receiving a transaction request, wherein the transaction request contains a transaction information; processing the transaction information to create a block for the transaction information, in response to the transaction request; and storing the block in a blockchain, wherein the blockchain includes at least one of a main chain blockchain of the main chain system and a parallel chain blockchain of a target parallel chain system, and the target parallel chain system includes at least one parallel chain system of the plurality of parallel chain systems.

Another aspect of the present disclosure provides a method of processing an information, applied to a supervision parallel chain system, wherein the supervision parallel chain system is one of a plurality of parallel chain systems in a supply chain management system, the supply chain management system further includes a main chain system connected to the plurality of parallel chain systems, cach of the parallel chain systems corresponds to a business scenario, and an information sharing between the plurality of parallel chain systems is implemented based on the main chain system; and the method includes: determining an inspector according to an inspection assignment rule in response to a supervision request, so that the inspector generates, in response to determining that a problem exists in a project corresponding to a project identification contained in the supervision request, a project rectification information according to a project information of the project; storing the project rectification information in a parallel chain blockchain of the supervision parallel chain system; and synchronously storing the project rectification information in a main chain blockchain of the main chain system by using a cross-chain method.

Another aspect of the present disclosure provides a apparatus of creating a blockchain-based supply chain management system, including: a first acquisition module configured to acquire a creation request for creating the supply chain management system, wherein the creation request contains a business information related to creating the supply chain management system; and a first response module configured to create the supply chain management system according to the business information and a blockchain basic architecture, in response to the creation request, wherein, the blockchain basic architecture includes an interface layer, a management layer, a core layer and a base layer, the supply chain management system includes a main chain system and a plurality of parallel chain systems connected to the main chain system, each of the parallel chain systems corresponds to a business scenario, and an information sharing between the plurality of parallel chain systems is implemented based on the main chain system.

Another aspect of the present disclosure provides an apparatus of processing an information, applied to a supply chain management system, wherein the supply chain management system includes a main chain system and a plurality of parallel chain systems connected to the main chain system, each of the parallel chain systems corresponds to a business scenario, and an information sharing between the plurality of parallel chain systems is implemented based on the main chain system; and the apparatus includes: a second response module configured to verify, in response to an authority verification request, a user information contained in the authority verification request, wherein the authority verification request requests to verify whether a user corresponding to the user information has an information query authority or not; a second acquisition module configured to acquire an information query request in response to a verification result of the user corresponding to the user information having the information query authority, wherein the information query request contains an information identification; a third response module configured to determine, in response to the information query request, a blockchain storing a transaction information corresponding to the information identification, wherein the blockchain includes at least one of a main chain blockchain of the main chain system and a parallel chain blockchain of the parallel chain systems; and a third acquisition module configured to acquire the transaction information from the blockchain storing the transaction information corresponding to the information identification.

Another aspect of the present disclosure provides an apparatus of storing an information, applied to a supply chain management system, wherein the supply chain management system includes a main chain system and a plurality of parallel chain systems connected to the main chain system, each of the parallel chain systems corresponds to a business scenario, and an information sharing between the plurality of parallel chain systems is implemented based on the main chain system; and the apparatus includes: a receiving module configured to receive a transaction request, wherein the transaction request contains a transaction information; a fifth response module configured to process the transaction information to create a block for the transaction information, in response to the transaction request; and a first storage module configured to store the block in a blockchain, wherein the blockchain includes at least one of a main chain blockchain of the main chain system and a parallel chain blockchain of a target parallel chain system, and the target parallel chain system includes at least one parallel chain system of the plurality of parallel chain systems.

Another aspect of the present disclosure provides an apparatus of processing an information, applied to a supervision parallel chain system, wherein the supervision parallel chain system is one of a plurality of parallel chain systems in a supply chain management system, the supply chain management system further includes a main chain system connected to the plurality of parallel chain systems, each of the parallel chain systems corresponds to a business scenario, and an information sharing between the plurality of parallel chain systems is implemented based on the main chain system; and the apparatus includes: a sixth response module configured to determine an inspector according to an inspection assignment rule in response to a supervision request, so that the inspector generates, in response to determining that a problem exists in a project corresponding to a project identification contained in the supervision request, a project rectification information according to a project information of the project; a second storage module configured to store the project rectification information in a parallel chain blockchain of the supervision parallel chain system; and a first synchronization module configured to synchronously store the project rectification information in a main chain blockchain of the main chain system by using a cross-chain method.

Another aspect of the present disclosure provides an electronic device, including: one or more processors; and a memory for storing one or more programs, wherein the one or more programs, when executed by the one or more processors, cause the one or more processors to implement the method described above.

Another aspect of the present disclosure provides a computer-readable medium having executable instructions stored thereon, wherein the instructions, when executed by a processor, cause the processor to implement the method described above.

Another aspect of the present disclosure provides a computer program product containing a computer program, wherein the computer program, when executed by a processor, causes the processor to implement the method described above.

### BRIEF DESCRIPTION OF THE DRAWINGS

The above and other objectives, features and advantages of the present disclosure will be more apparent through the following description of embodiments of the present disclosure with reference to the accompanying drawings.

FIG. 1 schematically shows an exemplary system architecture to which a method and apparatus of creating a blockchain-based supply chain management system, a method and an apparatus of processing an information, and a method and an apparatus of storing an information may be applied.

FIG. 2 schematically shows a flowchart of a method of creating a blockchain-based supply chain management system according to an embodiment of the present disclosure.

FIG. 3 schematically shows a schematic diagram of a process of creating a blockchain-based supply chain management system according to an embodiment of the present disclosure.

FIG. 4 schematically shows a schematic diagram of a blockchain-based supply chain management system according to an embodiment of the present disclosure.

FIG. 5 schematically shows a method of processing an information according to an embodiment of the present disclosure.

FIG. 6 schematically shows a schematic diagram of a process of acquiring a transaction information corresponding to an information identification from a blockchain storing the transaction information.

FIG. 7 schematically shows a flowchart of a method of storing an information according to an embodiment of the present disclosure.

FIG. 8 schematically shows a schematic diagram of a process of storing a device life cycle information in a blockchain according to an embodiment of the present disclosure.

FIG. 9 schematically shows a flowchart of a method of processing an information according to another embodiment of the present disclosure.

FIG. 10 schematically shows a block diagram of an apparatus of creating a blockchain-based supply chain management system according to an embodiment of the present disclosure.

FIG. 11 schematically shows a block diagram of an apparatus of processing an information according to an embodiment of the present disclosure.

FIG. 12 schematically shows a block diagram of an apparatus of storing an information according to an embodiment of the present disclosure.

FIG. 13 schematically shows a block diagram of an apparatus of processing an information according to another embodiment of the present disclosure.

FIG. 14 schematically shows a block diagram of an electronic device suitable for implementing the above-described method according to an embodiment of the present disclosure.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of the present disclosure. In the following detailed description, for case of interpretation, many specific details are set forth to provide a comprehensive understanding of the embodiments of the present disclosure. However, it is clear that one or more embodiments may also be implemented without these specific details. In addition, in the following description, descriptions of well-known structures and technologies are omitted to avoid unnecessarily obscuring the concepts of the present disclosure.

The terms used herein are for the purpose of describing specific embodiments only and are not intended to limit the present disclosure. The terms “comprising”, “including”, etc. used herein indicate the presence of the feature, step, operation and/or part, but do not exclude the presence or addition of one or more other features, steps, operations or parts.

All terms used herein (including technical and scientific terms) have the meanings generally understood by those skilled in the art, unless otherwise defined. It should be noted that the terms used herein shall be interpreted to have meanings consistent with the context of this specification, and shall not be interpreted in an idealized or too rigid way.

In a case of using the expression similar to “at least one of A, B and C”, it should be explained according to the meaning of the expression generally understood by those skilled in the art (for example, “a system including at least one of A, B and C” should include but not be limited to a system including only A, a system including only B, a system including only C, a system including A and B, a system including A and C. a system including B and C, and/or a system including A, B and C). In a case of using the expression similar to “at least one of A, B or C”, it should be explained according to the meaning of the expression generally understood by those skilled in the art (for example, “a system including at least one of A, B or C” should include but not be limited to a system including only A, a system including only B, a system including only C, a system including A and B, a system including A and C, a system including B and C. and/or a system including A, B and C).

A supply chain system may include a supply chain formed based on a core enterprise, an upstream enterprise of the core enterprise and a downstream enterprise of the core enterprise. Operations such as planning, purchasing, manufacturing, delivery and return may be involved between the core enterprise, the upstream enterprise and the downstream enterprise. The supply chain system may be managed using a supply chain management system. For example, the supply chain system may be a supply chain system for a panel industry. The core enterprise may include a panel manufacturer. The upstream enterprise may include at least one of a device manufacturer, a material manufacturer, a system integration enterprise, and a device operation and maintenance enterprise. The downstream enterprise may include a terminal device manufacturer.

In a process of achieving a concept of the present disclosure, it is found that a management effect of the supply chain management system is not good, which is caused by the following two aspects.

A first aspect is a lack of an information sharing mechanism. A phenomenon of information islands exists in the supply chain management system, which makes the upstream and downstream of the supply chain disconnected, affects an efficiency of the supply chain system, and then affects the management effect of the supply chain management system. The phenomenon of information islands may refer to a phenomenon that an enterprise tries to avoid sharing information with other enterprises due to its own need. For example, the core enterprise does not share an inventory information with the upstream enterprise, so that it is difficult for the upstream enterprise to acquire a real inventory information of the core enterprise and prepare goods according to the real inventory information, which increases an inventory pressure on all parties and is not conducive to a virtuous cycle of capital flow.

A second aspect is a low reliability of information. Since the information of cach party is independently managed, there is a risk of information being tampered with. Accordingly, it is difficult to ensure the reliability of the information, which further aggravates the existence of information islands and affects the management effect of the supply chain management system.

In a process of achieving the concept of the present disclosure, it is found that the management effect of the supply chain management system may be improved by increasing a degree of information sharing between parties in the supply chain management system and enhancing the reliability of information. It is further found that a blockchain may be used to improve the degree of information sharing and the reliability of information. This is because the blockchain is a solution that uses a blockchain data structure to verify and store data, uses a distributed node consensus algorithm to generate and update data, uses cryptography to ensure a security of data transmission and access, and uses a smart contract collective composed of automated script code to maintain a reliable database. Therefore, the blockchain has basic characteristics such as openness, decentralization, information sharing, tamper resistance and traceability. For the decentralization, data verification, storage, maintenance and ledger processes of the blockchain are performed based on a distributed system structure, and a mutual trust between distributed nodes is created using a pure mathematical method, so that a decentralized and trusted distributed system is formed. For the information sharing, all transaction information in the blockchain network is open and shared, and blockchain nodes may verify blocks and query information of the blockchain, so that an information sharing network may be implemented. For the tamper resistance, once the block in the blockchain network is confirmed, its transaction information may be permanently stored in the blockchain, and a next block may contain the information of the previous block. If someone wants to tamper with the transaction information, a hash value of the block may be affected. Accordingly, the hash values of other blocks have to be modified to a certain extent in order to successfully tamper with the transaction information. Such operations are very difficult, and the cost is far greater than the benefits. Therefore, the information stored in the blockchain may hardly be tampered with. For the traceability, each block header in the blockchain contains the hash value, Merkel tree and other features of the previous block, so that the information may be traced.

Because the above basic characteristics of blockchain are consistent with the need to improve the degree of information sharing and the reliability of information in the supply chain management, the blockchain may be applied to the supply chain management system.

According to a network scope, the blockchain may be divided into a public chain, a private chain, an alliance chain and a hybrid chain. The alliance chain refers to a blockchain jointly participated in and managed by several institutions. Each institution may run at least one blockchain node. Data of the alliance chain may only be read, written and traded by institutions in the alliance chain system, and an initiation of identity management system, transactions or proposals based on PKI (Public Key Infrastructure) may be implemented through digital certificates, so as to reach a consensus through a joint signature and verification of the participants. In the embodiments of the present disclosure, the type of blockchain may be selected according to the actual business needs, which is not limited here. For example, both the main chain system and the parallel chain system may be blockchain systems created based on the alliance chain.

The blockchain system may include a plurality of blockchain nodes, which communicate through P2P (Peer to Peer). The blockchain node may be either a client or a server. That is, the blockchain node may not only request services from other blockchain nodes, but also provide services for other blockchain nodes or external applications.

According to the node type, the blockchain node may be divided into an endorsement node, a sorting node, a verification node, a consensus node or a supervision node. The consensus node may be used to package the transaction information to generate a new block, and may be used to verify a validity of the transaction information and the block. The verification node may be used to synchronize and verify the transaction information and the block, and does not participate in consensus. The supervision node may be a blockchain node whose public key information and internet protocol address are authorized by a user with a super management authority. The supervision node may store the full information, and has functions of accessing a database of the blockchain system, counting a transaction behavior, reviewing a transaction of the blockchain node, and identifying an identity of the blockchain node. In addition, the supervision node may further have a function of restricting a transaction and freezing an account number.

In a process of applying the blockchain to the supply chain management system, it is found that since the supply chain management system includes a plurality of types of enterprises and involves a plurality of business functions, if a blockchain system including all information is created for each business function involved, the creation cost and maintenance cost may be increased. Therefore, it is necessary to set a mode of the blockchain system. It is found that the mode of using a main chain system and a parallel chain system may meet the above requirements. That is, the supply chain management system may include a main chain system and a plurality of parallel chain systems, and cach business scenario corresponds to a parallel chain system. A main chain blockchain of the main chain system may store the full information of the supply chain system, and a parallel chain blockchain of each parallel chain system stores an information of a corresponding business scenario without storing an information of other business scenarios. That is, the parallel chain blockchain of the parallel chain system stores partial information rather than the full information. Different parallel chain systems may share information based on the main chain.

Based on the above contents, the embodiments of the present disclosure propose a solution of a blockchain-based supply chain management system, that is, a supply chain management system including a main chain system and a plurality of parallel chain systems is created based on a business information and a blockchain basic architecture, and information sharing between different parallel chain systems may be implemented based on the main chain system. On this basis, the supply chain management system created based on the blockchain may be used for information processing and information storage.

The embodiments of the present disclosure provide a method of creating a blockchain-based supply chain management system, a method of processing an information, a method of storing an information, an electronic device, a computer-readable storage medium, and a computer program product. The creation method includes: acquiring a creation request for creating a supply chain management system, where the creation request contains a business information related to creating the supply chain management system; and creating the supply chain management system according to the business information and a blockchain basic architecture, in response to the creation request. The blockchain basic architecture includes an interface layer, a management layer, a core layer and a base layer. The supply chain management system includes a main chain system and a plurality of parallel chain systems connected to the main chain system, cach of the parallel chain systems corresponds to a business scenario, and an information sharing between the plurality of parallel chain systems is implemented based on the main chain system.

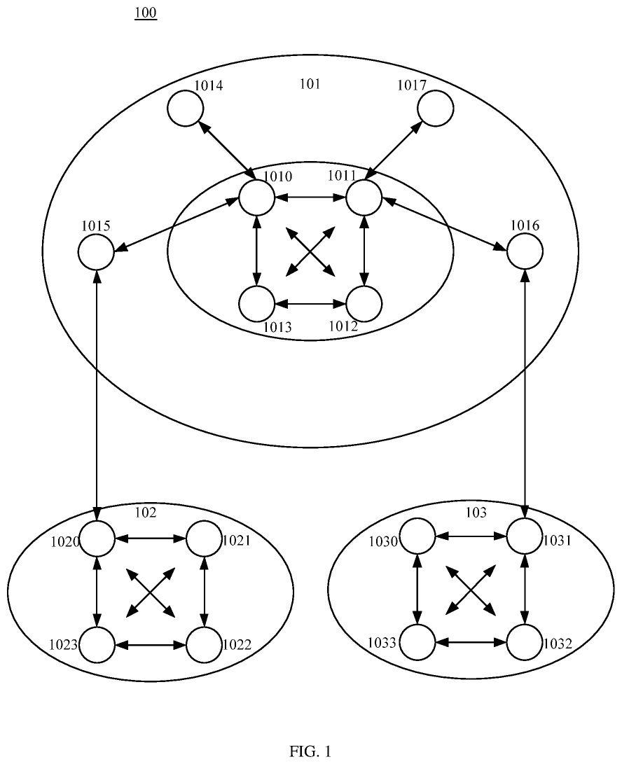

FIG. 1 schematically shows an exemplary system architecture to which a method and an apparatus of creating a blockchain-based supply chain management system, a method and an apparatus of processing an information, and a method and an apparatus of storing an information may be applied. It should be noted that FIG. 1 is only an example of a system architecture in which the embodiments of the present disclosure may be applied, so as to help those skilled in the art to understand the technical content of the present disclosure. It does not mean that the embodiments of the present disclosure may not be applied to other apparatuses, systems, environments or scenes.

As shown in FIG. 1, a system architecture 100 according to the embodiment may include a main chain system 101, a parallel chain system 102, and a parallel chain system 103.

The main chain system 101 may include a blockchain node 1010, a blockchain node 1011, a blockchain node 1012, a blockchain node 1013, a blockchain node 1014, a blockchain node 1015, a blockchain node 1016, and a blockchain node 1017. The blockchain node 1010, the blockchain node 1011, the blockchain node 1012 and the blockchain node 1013 are consensus nodes, the blockchain node 1014, the blockchain node 1015 and the blockchain node 1016 are verification nodes, and the blockchain node 1017 is a supervision node.

The parallel chain system 102 may include a blockchain node 1020, a blockchain node 1021, a blockchain node 1022, and a blockchain node 1023. The blockchain node 1020 and the blockchain node 1021 are consensus nodes, and the blockchain node 1022 and the blockchain node 1023 are verification nodes.

The parallel chain system 103 may include a blockchain node 1030, a blockchain node 1031, a blockchain node 1032, and a blockchain node 1033. The blockchain node 1030 is a consensus node, and the blockchain node 1031, the blockchain node 1032 and the blockchain node 1033 are verification nodes.

The parallel chain system 102 and the parallel chain system 103 may be communicatively connected to the main chain system 101 respectively, and the parallel chain system 102 and the parallel chain system 103 are not communicatively connected. The parallel chain system 102 and the parallel chain system 103 may achieve an information interaction based on the main chain system 101, and the parallel chain 102 and the parallel chain 103 is information-isolated from each other.

The blockchain node may be a terminal device or a server. The terminal device may be various electronic devices having a display screen and supporting web browsing, including but not limited to a smart phone, a tablet computer, a laptop computer, a desktop computer, and the like. The server may be a variety of types of servers that provide various services. For example, the server may be a cloud server, also known as a cloud computing server or a cloud host. It is a host product in a cloud computing service system to solve shortcomings of difficult management and weak business scalability existing in a traditional physical host and VPS (Virtual Private Server) service. The server may also be an edge server. The server may also be a server of a distributed system or a server combined with a blockchain.

It should be understood that the number of main chain system, parallel chain system and blockchain nodes in FIG. 1 is only schematic. Any number of main chain systems, parallel chain systems and blockchain nodes may be provided according to implementation needs.

FIG. 2 schematically shows a flowchart of a method of creating a blockchain-based supply chain management system according to the embodiments of the present disclosure.

As shown in FIG. 2, a method 200 includes operations S210 to S220.

In operation S210, a creation request for creating a supply chain management system is created, and the creation request contains a business information related to creating the supply chain management system.

In operation S220, the supply chain management system is created according to the business information and a blockchain basic architecture, in response to the creation request.

According to the embodiments of the present disclosure, the blockchain basic architecture may include an interface layer, a management layer, a core layer and a base layer. The supply chain management system may include a main chain system and a plurality of parallel chain systems connected to the main chain system, each of the parallel chain systems corresponds to a business scenario, and an information sharing between the plurality of parallel chain systems is implemented based on the main chain system.

According to the embodiments of the present disclosure, the business information may include a demand information related to the creation of the supply chain management system. For example, the demand information may contain a business function and a parameter information related to the business function. The business function may include at least one of a warehouse management function, a supply chain function and a supervision function. The business scenario may be determined according to the business function. The business scenario may include a warehouse management scenario, a supply chain scenario, and a supervision scenario.

According to the embodiments of the present disclosure, the base layer included in the blockchain basic architecture may be used to provide a basic data structure and an algorithm library of the blockchain. The algorithm library may include at least one of cryptographic algorithm, privacy algorithm, database driver, basic library, disk IO, Socket, etc. The core layer may be used to implement a core logic of the blockchain. The core logic may include at least one of blockchain's distributed storage, blockchain management, P2P network and consensus algorithm. The core layer may include a chain core layer and an interconnection core layer. The management layer may be used to achieve a management function of the blockchain. The management layer may include at least one of an authority management and a parameter management, etc. The interface layer may be used to provide interfaces of various protocols, so that a blockchain developer may achieve an interaction with the blockchain through RPC (Remote Procedure Call) interface, SDK (Software Development Kit) or interactive console. The interface may include at least one of a transaction interface, a query interface and a supervision interface, etc.

According to the embodiments of the present disclosure, the supply chain management system including the main chain system and the plurality of parallel chain systems may be created according to the business information and the blockchain basic architecture. Both the main chain system and the parallel chain system may include a plurality of blockchain nodes. Both the main chain system and the parallel chain system may be alliance chains. Each parallel chain system may be used to achieve an internal trusted sharing for a corresponding business scenario. The parallel chain system may include a communication node for communicating with the main chain system, that is, an information sharing between the parallel chain system and the main chain system may be implemented using the communication node. Different parallel chain systems are information-isolated from each other. If required, the information sharing between different parallel chains may be implemented based on the main chain system. That is, the information sharing between different parallel chain systems may be implemented based on the main chain system. This is because the transaction information to be shared may be stored in the main chain blockchain of the main chain system, and the shared transaction information may be acquired from the main chain system.

According to the embodiments of the present disclosure, the main chain system may store the full transaction information of the supply chain management system, and the full transaction information includes the transaction information stored in each parallel chain blockchain. The main chain system may also store partial transaction information of the supply chain management system. When it is determined that the main chain system stores partial transaction information of the supply chain management system, the information sharing between different parallel chain systems may be implemented as follows based on the main chain system. When it is determined that the transaction information is a target transaction information, the transaction information may be stored outside the target parallel chain system, and the transaction information may also be stored in the main chain system, so that the blockchain node belonging to a non-target parallel chain system may acquire the transaction information stored in the parallel chain blockchain of the target parallel chain system from the main chain blockchain of the main chain system. The target transaction information may refer to a transaction information in a type of shared information. When it is determined that the main chain system stores the full transaction information of the supply chain management system, the transaction information may be directly stored in the target parallel chain system and the main chain system, and it does not need to perform an operation of determining whether the transaction information is the target transaction information.

According to the embodiments of the present disclosure, in response to the creation request, the supply chain management system including the main chain system and the plurality of parallel chain systems connected to the main chain system is created according to the business information and the blockchain basic architecture including the interface layer, the management layer, the core layer and the base layer. Since the information sharing between the plurality of parallel chain systems is implemented based on the main chain system and the main chain system and the parallel chain system are created based on the blockchain, a degree of information sharing and a reliability of information may be improved, and then a management effect of the supply chain management system may be improved. In addition, the supply chain management system created by using the mode of main chain system and parallel chain system may reduce the creation cost and maintenance cost on the basis of effectively ensuring the management effect of the supply chain management system.

According to the embodiments of the present disclosure, operation S220 may include the following operations.

A configuration information is determined according to the business information. The configuration information includes a node information, a smart contract information and an authority information. The supply chain management system is created according to the configuration information and the blockchain basic architecture.

According to the embodiments of the present disclosure, the node information may contain at least one of a number of nodes and a node type for each business scenario. The smart contract information may represent a smart contract that may run on the blockchain system. The smart contract may include at least one of an inventory-related smart contract, a purchase-related smart contract, a production-related smart contract, a quality management-related smart contract, a supervision-related smart contract, a payment-related smart contract, and a logistics-related smart contract. The authority information may represent an authority of the blockchain node. The authority may include at least one of a storage authority, a transaction authority and a query authority. The configuration information for different business scenarios may be the same or different.

According to the embodiments of the present disclosure, the business information may be analyzed to obtain the configuration information, and then the configuration information may be combined with the blockchain basic architecture. That is, the blockchain basic architecture may be set according to the configuration information to obtain the supply chain management system including the main chain system and the plurality of parallel chain systems.

According to the embodiments of the present disclosure, a complexity of a smart contract running on the parallel chain system may be greater than a complexity of a smart contract running on the main chain system.

According to the embodiments of the present disclosure, the main chain system may run a basic core smart contract, and the parallel chain system may run a more complex smart contract, such as a smart contract related to the corresponding business scenario. Because the more complex smart contract may run on the parallel chain system and the main chain system runs the basic core smart contract, a stability of the main chain system and a stability of the entire supply chain management system may be effectively ensured. In an example, the smart contract running on the main chain system may be used for storage, and the smart contract running on the parallel chain system may be used for the business scenario. The complexity may include at least one of a number of smart contracts, an amount of data, and a number of operations to be performed.

According to the embodiments of the present disclosure, each parallel chain system is connected to the main chain system through a remote procedure call protocol interface.

According to the embodiments of the present disclosure, the remote procedure call protocol is a protocol that requests a service from a remote computer program over a network without understanding an underlying network technology. The remote procedure call interface may include a GRPC interface, which is a high-performance, open source and general RPC framework.

According to the embodiments of the present disclosure, the plurality of parallel chain systems include a supply chain parallel chain system, a warehouse management parallel chain system, and a supervision parallel chain system.

According to the embodiments of the present disclosure, the supply chain parallel chain system may be used to perform a management of a supply system. The warehouse management parallel chain system may be used to perform a management of a warehouse system. The supervision parallel chain system may be used to perform at least one of a quality evaluation, an inventory management and an order management.

According to the embodiments of the present disclosure, any two of the supply chain parallel chain system, the warehouse management parallel chain system and the supervision parallel chain system are information-isolated from each other, but all may share information with the main chain system. If two information-isolated parallel chain systems need to share information, the information sharing may be implemented based on the main chain system.

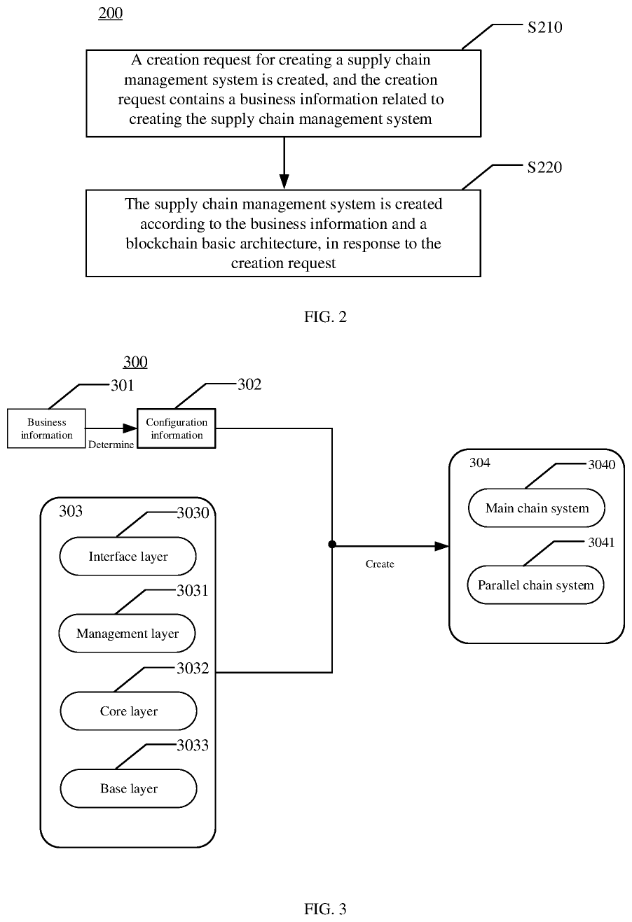

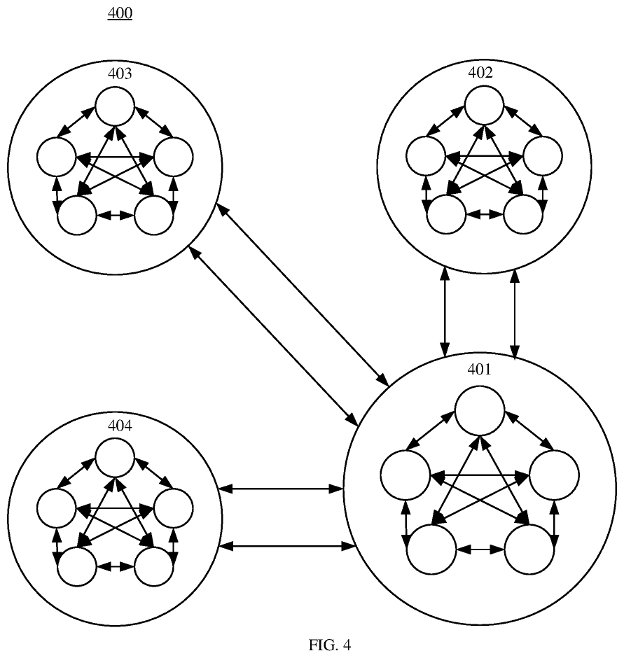

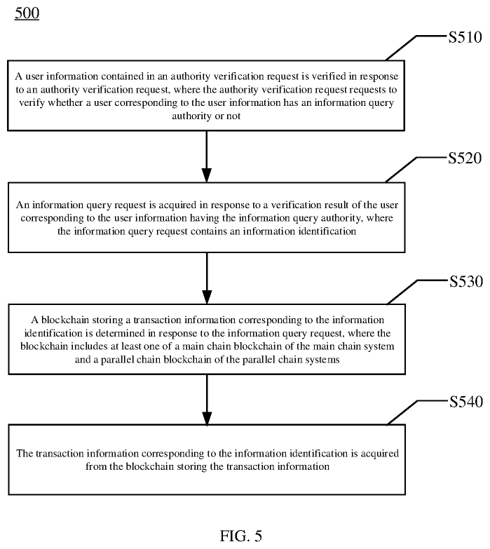

Next, the method of creating the blockchain-based supply chain management system according to the embodiments of the present disclosure will be further described with reference to FIG. 3 to FIG. 4 and specific embodiments.

FIG. 3 schematically shows a schematic diagram of a process of creating a blockchain-based supply chain management system according to the embodiments of the present disclosure.

As shown in FIG. 3, in a creation process 300, a configuration information 302 may be determined according to a business information 301, and a supply chain management system 304 may be created according to the configuration information 302 and a blockchain basic architecture 303. The blockchain basic architecture may include an interface layer 3030, a management layer 3031, a core layer 3032 and a base layer 3033. The supply chain management system 304 may include a main chain system 3040 and a plurality of parallel chain systems 3041.

FIG. 4 schematically shows a schematic diagram of a blockchain-based supply chain management system according to the embodiments of the present disclosure.

As shown in FIG. 4, a blockchain-based supply chain management system 400 may include a main chain system 401, a supply chain parallel chain system 402, a warehouse management parallel chain system 403, and a supervision parallel chain system 404. The supply chain parallel chain system 402, the warehouse management parallel chain system 403 and the supervision parallel chain system 404 may be communicatively connected to the main chain system 401 respectively. The supply chain parallel chain system 402, the warehouse management parallel chain system 403 and the supervision parallel chain system 404 may achieve information sharing based on the main chain system 401, and any two of them are information-isolated from each other.

For example, the parallel chain blockchain of the supply chain parallel chain system 402 stores an order information. A parallel chain blockchain of the warehouse management parallel chain 403 stores a quality information. The supervision parallel chain system 404 stores a supervision information. A main chain blockchain of the main chain system 401 stores the order information, the quality information and the supervision information.

The information sharing between the supply chain parallel chain system 402 and the supervision parallel chain system 404 may be implemented based on the main chain system 401. If a blockchain node of the supply chain parallel chain system 402 needs to acquire the supervision information, and the supervision information is stored in the parallel chain blockchain of the supervision parallel chain system 404 and the main chain blockchain of the main chain system 401 but not in the parallel chain blockchain of the supply chain parallel chain system 402, then the blockchain node of the supply chain parallel chain system 402 may acquire the supervision information from the main chain blockchain of the main chain system 401.

The information sharing between the supply chain parallel chain system 402 and the warehouse management parallel chain system 403 may be implemented based on the main chain system 401. If a blockchain node of the warehouse management parallel chain system 403 needs to acquire the order information, and the order information is stored in the parallel chain blockchain of the supply chain parallel chain system 402 and the main chain blockchain of the main chain system 401 but not in the parallel chain blockchain of the warehouse management parallel chain system 403, then the blockchain node of the warehouse management parallel chain system 403 may acquire the order information from the main chain blockchain of the main chain system 401.

The information sharing between the warehouse management parallel chain system 403 and the supervision parallel chain system 404 may be implemented based on the main chain system 401. If a blockchain node of the supervision parallel chain system 404 needs to acquire the quality information, and the quality information is stored in the parallel chain blockchain of the warehouse management parallel chain system 403 and the main chain blockchain of the main chain system 401 but not in the parallel chain blockchain of the supervision parallel chain system 404, then the blockchain node of the supervision parallel chain system 404 may acquire the supervision information from the main chain blockchain of the main chain system 401.

FIG. 5 schematically shows a method of processing an information according to the embodiments of the present disclosure.

According to the embodiments of the present disclosure, the method of processing the information may be applied to the supply chain management system. The supply chain management system may include a main chain system and a plurality of parallel chain systems connected to the main chain system, each of the parallel chain systems corresponds to a business scenario, and an information sharing between the plurality of parallel chain systems is implemented based on the main chain system. The supply chain management system is created according to the method of creating the blockchain-based supply chain management system described in the embodiments of the present disclosure.

As shown in FIG. 5, a method 500 may include operations S510 to S540.

In operation S510, a user information contained in an authority verification request is verified in response to an authority verification request. The authority verification request requests to verify whether a user corresponding to the user information has an information query authority or not.

In operation S520, an information query request is acquired in response to a verification result of the user corresponding to the user information having the information query authority, where the information query request contains an information identification.

In operation S530, a blockchain storing a transaction information corresponding to the information identification is determined in response to the information query request. The blockchain includes at least one of a main chain blockchain of the main chain system and a parallel chain blockchain of the parallel chain systems.

In operation S540, the transaction information corresponding to the information identification is acquired from the blockchain storing the transaction information.

According to the embodiments of the present disclosure, the authority verification request may contain the user information, and the user information may include a user name and a user password. The user information may be stored in a record management system, which may be used to store a user information of a user with the information query authority. The record management system may display a user registration page in response to a user registration request. The user registration page may contain at least one of an input box and a confirmation control. The input box may be a control for entering at least one of a user name, a user password, a contact information and a verification code. The user information may be obtained and stored in response to a user input operation on the input box and a click operation on the confirmation control.

According to the embodiments of the present disclosure, the transaction information may be a transaction information stored in the blockchain, and the blockchain may include at least one of the main chain blockchain of the main chain system and the parallel chain blockchain of the parallel chain system. The transaction information may be stored in the blockchain in the way as follows. In response to the transaction request, the supply chain management system processes the transaction information contained in the transaction request, creates a block for the transaction information, and stores the block in the blockchain.

According to the embodiments of the present disclosure, the supply chain management system verifies the user information contained in the authority verification request in response to the authority verification request, so as to obtain a verification result. If the verification result indicates that the user corresponding to the user information has the information query authority, a blockchain storing the transaction information corresponding to the information identification may be determined according to the information identification contained in the information query request, in response to the information query request. Since the main chain blockchain stores the full transaction information of the supply chain management system, the full transaction information includes the transaction information stored in cach parallel chain blockchain, and each parallel chain blockchain stores the transaction information related to the parallel chain system, then the blockchain storing the transaction information corresponding to the information identification may be the main chain blockchain of the main chain system, or may include at least one of the main chain blockchain of the main chain system and the parallel chain blockchain of the parallel chain system. If the verification result indicates the user corresponding to the user information does not have the information query authority, an execution of a subsequent operation may be ended. After the blockchain storing the transaction information corresponding to the information identification is determined, the transaction information may be acquired from the blockchain storing the transaction information corresponding to the information identification.

For example, the user corresponding to the user information may have the information query authority to query the transaction information stored in the parallel chain blockchain of the supervision parallel chain system. The supervision parallel chain system may respond to the authority verification request. If it is determined that the user corresponding to the user information has the information query authority, the transaction information corresponding to the information identification contained in the information query request may be acquired from the parallel chain blockchain of the supervision parallel chain system. According to the embodiments of the present disclosure, the user information contained in the authority verification request is verified in response to the authority verification request. When it is determined that the user corresponding to the user information has the information query authority, the information query request is acquired. The blockchain storing the transaction information corresponding to the information identification is determined in response to the information query request, and the transaction information is acquired from the blockchain storing the transaction information corresponding to the information identification. In this way, a query of the transaction information is implemented by using the supply chain management system created based on the blockchain.

According to the embodiments of the present disclosure, operation S540 may include the following operations.

When it is determined that the blockchain system the blockchain storing the transaction information corresponding to the information identification belongs to includes at least one of a first parallel chain system and the main chain system and that a blockchain system corresponding to a blockchain node for generating the authority verification request is a second parallel chain system, the transaction information corresponding to the information identification is acquired from the main chain blockchain. The first parallel chain system and the second parallel chain system are parallel chain systems in the plurality of parallel chain systems.

When it is determined that the blockchain system the blockchain storing the transaction information corresponding to the information identification belongs to includes at least one of the first parallel chain system and the main chain system and that the blockchain system corresponding to the blockchain node for generating the authority verification request is the first parallel chain system, the transaction information is acquired from the blockchain storing the transaction information corresponding to the information identification.

When it is determined that the blockchain system the blockchain storing the transaction information corresponding to the information identification belongs to is the main chain system and that the blockchain system corresponding to the blockchain node for generating the authority verification request is the main chain system, the transaction information corresponding to the information identification is acquired from the main chain blockchain.

According to the embodiments of the present disclosure, the first parallel chain system may refer to a parallel chain system of which the parallel chain blockchain stores the transaction information corresponding to the information identification. The second parallel chain system may refer to a parallel chain system of which the parallel chain blockchain does not store the transaction information corresponding to the information identification. The main chain blockchain may contain the full transaction information, which may include the transaction information stored in the parallel chain blockchain of the first parallel chain system and the transaction information stored in the parallel chain blockchain of the second parallel system,

The first parallel chain system may include a plurality of blockchain nodes. The blockchain nodes of the first parallel chain system have the information query authority for at least one of the parallel chain blockchain of the first parallel chain system, the main chain blockchain of the main chain system, and a parallel chain blockchain of a first other parallel chain system. The first other parallel chain system may refer to a parallel chain system other than the first parallel chain system, in which the blockchain stores the transaction information corresponding to the information identification contained in the information query request. The first other parallel chain system may include a second parallel chain blockchain, and the first other parallel chain system may include one or more parallel chain systems.

According to the embodiments of the present disclosure, the second parallel chain system may include a plurality of blockchain nodes. The blockchain nodes of the second parallel chain system have the information query authority for at least one of the parallel chain blockchain of the second parallel chain system, the main chain blockchain of the main chain system, and a parallel chain blockchain of a second other parallel chain system. The second other parallel chain system may refer to a parallel chain system other than the second parallel chain system, in which the blockchain stores the transaction information corresponding to the information identification contained in the information query request. The second other parallel chain system may include a first parallel chain blockchain, and the second other parallel chain system may include one or more parallel chain systems.

When it is determined that the blockchain node for generating the authority verification request is a blockchain node with information query authority and that the blockchain node for generating the authority verification request is a blockchain node of the first parallel chain system, if it is determined that the blockchain storing the transaction information corresponding to the information identification includes at least one of the parallel chain blockchain of the second parallel chain system and the main chain blockchain of the main chain system, the transaction information may be acquired from the main chain blockchain of the main chain system. If it is determined that the blockchain storing the transaction information corresponding to the information identification is the parallel chain blockchain of the first parallel chain system or the main chain blockchain of the main chain system, the transaction information may be acquired from the parallel chain blockchain of the first parallel chain system or the main chain blockchain of the main chain system. If it is determined that the blockchain system the blockchain storing the transaction information corresponding to the information identification belongs to is the main chain system, the transaction information corresponding to the information identification may be acquired from the main chain blockchain.

For example, the supply chain management system may include a supply chain parallel chain system and a supervision parallel chain system. The parallel chain blockchain of the supply chain parallel chain system stores an order information, and the supervision parallel chain system stores a supervision information. The main chain blockchain of the main chain system stores the order information and the supervision information.

If the supply chain parallel chain system is the first parallel chain system, the first other parallel chain system may include the warehouse management parallel chain system, and the second parallel chain system may include the supervision parallel chain system.

If the supervision parallel chain system is the first parallel chain system, the first other parallel chain system may include the supply chain parallel chain system, and the second parallel chain system may include the supply chain parallel chain system.

The first parallel chain system being the supply chain parallel chain system and the second parallel chain system being the supervision parallel chain system are illustrated below by way of example for description.

When the transaction information corresponding to the information identification is the supervision information, if it is determined that the blockchain system corresponding to the blockchain node for generating the authority verification request is the supervision parallel chain system and that the blockchain system the blockchain storing the transaction information corresponding to the information identification belongs to is the supervision parallel chain system, it means that the blockchain system corresponding to the blockchain node stores the supervision information that needs to be acquired. Thus, the supervision information may be directly acquired from the parallel chain blockchain of the supervision parallel chain system rather than based on the main chain system.

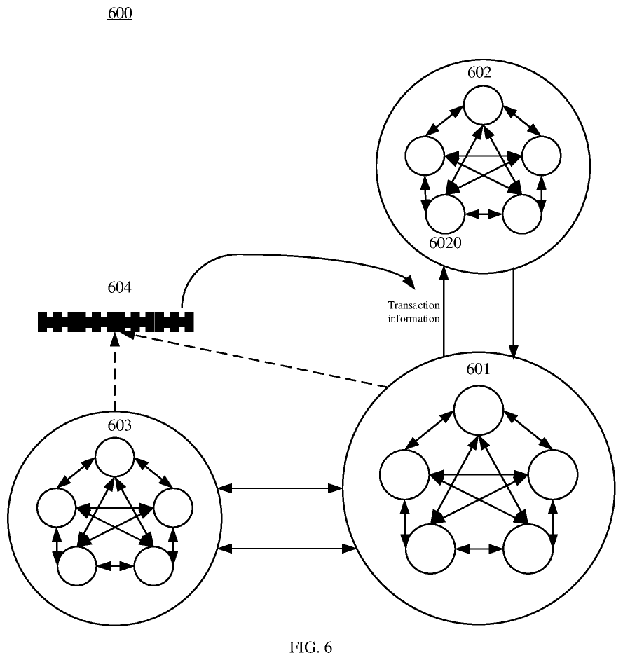

When the transaction information corresponding to the information identification is the order information, if it is determined that the blockchain system corresponding to the blockchain node for generating the authority verification request is the supervision parallel chain system and that the blockchain system the blockchain storing the transaction information corresponding to the information identification belongs to is the supply chain parallel chain system, it means that the blockchain system corresponding to the blockchain node does not store the order information that needs to be acquired. Therefore, the order information needs to be acquired from the main chain blockchain of the main chain system. FIG. 6 schematically shows a schematic diagram of a process of acquiring the transaction information from the blockchain storing the transaction information corresponding to the information identification.

As shown in FIG. 6, in a process 600, when it is determined that a blockchain system a blockchain 604 storing the transaction information corresponding to the information identification belongs to includes a first parallel chain system 603 and a main chain system 601 and that the blockchain system corresponding to a blockchain node 6020 for generating the authority verification request is the second parallel chain system 602, the transaction information corresponding to the information identification is acquired from the main chain blockchain.

According to the embodiments of the present disclosure, the user includes a supply object, and the transaction information includes an inventory information and a demand information related to a demand object.

The method of processing the information described above may further include an operation of transmitting the transaction information to the user so that the user may prepare goods according to the transaction information.

According to the embodiments of the present disclosure, the supply object may provide a product to the demand object. The product may include a production material or a product made from the production material. If the supply object includes the upstream enterprise, the demand object may include the core enterprise. If the supply object further includes the core enterprise, the demand object may further include the downstream enterprise.

In order to achieve an optimal allocation of resources, that is, in order that the supply object shortens a goods-preparing cycle and the demand object reduces a stocking number and a fixed redundant investment, a stock-related smart contract may be called to store the transaction information of the demand object into the blockchain. The supply object with information query authority may prepare goods according to the transaction information including the inventory information and the demand information.

According to the embodiments of the present disclosure, the user may include a demand object.

The method of processing the information as described above may further include an operation of calling a purchase-related smart contract in response to a purchase request from the demand object, so as to perform a purchase operation between the demand object and the supply object contained in the purchase request.

According to the embodiments of the present disclosure, the purchase request may refer to a request by the demand object to purchase a product of the supply object. The purchase request may contain at least one of the demand object, the supply object and a purchase information. The purchase information may include at least one of a purchase quantity, a purchase model and a purchase unit price of a purchase object. The purchase-related smart contract may be used to perform a purchase operation between the demand object and the supply object.

According to the embodiments of the present disclosure, in the process of achieving the concept of the present disclosure, it is further found that the involved purchase and other operations are difficult to perform automatically. Therefore, it may be performed based on a smart contract. The smart contract is a computer protocol designed to propagate, verify or execute a contract in an information-based manner, which allows a trusted transaction without a third party, and the transaction is traceable and irreversible. In the blockchain system, the smart contract is represented as executable codes, that is, scripts that are automatically executed on blockchain nodes when a preset condition is triggered and that may encode any rule set expressed in a programming language. The smart contract stored in the blockchain system may perform information storage, transaction, query and other operations according to a user operation, thereby reducing a human intervention.

According to the embodiments of the present disclosure, when the purchase request from the demand object is obtained, if the condition for triggering and executing the purchase-related smart contract is satisfied, the purchase-related smart contract is executed to perform the purchase operation between the demand object and the supply object. For example, the demand object is a terminal device manufacturer E, and the supply object is a panel manufacturer F. The terminal device manufacturer needs W OLED (Organic Electroluminescence Display) panels with Model T. The supply chain parallel chain system is provided with a blockchain node corresponding to the demand object and a blockchain node corresponding to the supply object.

The blockchain node corresponding to the terminal device manufacturer E generates a purchase request. The supply chain parallel chain system calls the purchase-related smart contract in response to the purchase request of the terminal device manufacturer E, executes the purchase-related smart contract and performs the purchase operation between the terminal device manufacturer E and the panel manufacturer F if the condition for triggering and executing the purchase-related smart contract is satisfied.

According to the embodiments of the present disclosure, an automatic contract purchase may be performed by calling the purchase-related smart contract, which is conducive to reducing inventory and reducing capital pressure.

According to the embodiments of the present disclosure, the purchase-related smart contract includes a purchase contract and a payment contract.

Calling a purchase-related smart contract in response to a purchase request from the demand object, so as to perform a purchase operation between the demand object and the supply object contained in the purchase request may include the following operations.

The purchase request from the demand object is acquired. The purchase request contains the demand object, the supply object and the purchase information. The purchase contract is called in response to the purchase request. A purchase event for the purchase information is generated using the purchase contract. The payment contract is called in response to acquiring a purchase confirmation information for the purchase event from the supply object. A purchase payment is performed using the payment contract.

According to the embodiments of the present disclosure, the purchase information may include at least one of a product name, a product category, a purchase quantity, a delivery time, a purchase price, an advance payment and a final payment, etc. The purchase information may be obtained by the blockchain node through a data acquisition using a data acquisition device. The data acquisition device includes at least one of a smart phone, a handheld computer scanner, or a point-of-sale terminal. The purchase contract may be a smart contract generated according to a product purchase logic. The payment contract may be a smart contract generated according to a product payment logic.

According to the embodiments of the present disclosure, in response to the purchase request from the blockchain node corresponding to the demand object, the purchase contract may be called to generate a purchase event for the purchase information, and the purchase event is stored in the blockchain so that the supply object may obtain the purchase event after a data synchronization with the blockchain node corresponding to the supply object.

According to the embodiments of the present disclosure, after the purchase confirmation information for the purchase event of the supply object is obtained, the payment contract may be called to perform the purchase payment between the demand object and the supply object based on the purchase information.

According to the embodiments of the present disclosure, after the purchase payment between the demand object and the supply object is performed, a payment voucher is generated and stored in the blockchain, so that the supply object may obtain the payment voucher after a data synchronization with the blockchain node corresponding to the supply object. After acquiring a delivery information for the purchase information that is submitted by the supply object after acquiring the payment voucher, the delivery contract is called to deliver the product contained in the purchase information based on the payment voucher. The delivery contract may be a smart contract generated according to a delivery logic.

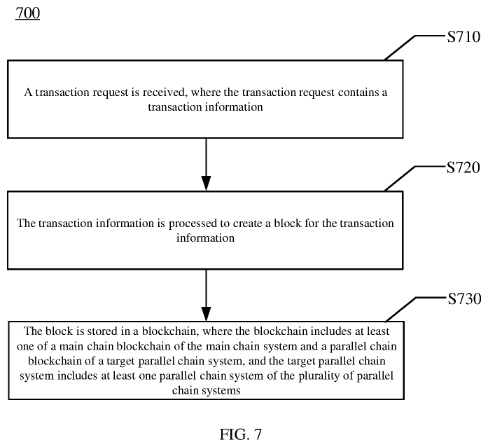

FIG. 7 schematically shows a flowchart of a method of storing an information according to the embodiments of the present disclosure.

According to the embodiments of the present disclosure, the method of storing the information may be applied to the supply chain management system. The supply chain management system may include a main chain system and a plurality of parallel chain systems connected to the main chain system, each of the parallel chain systems corresponds to a business scenario, and an information sharing between the plurality of parallel chain systems is implemented based on the main chain system. The supply chain management system is created according to the method of creating the blockchain-based supply chain management system described in the embodiments of the present disclosure.

As shown in FIG. 7, a method 700 includes operations S710 to S730.

In operation S710, a transaction request is received, and the transaction request contains a transaction information.

In operation S720, the transaction information is processed to create a block for the transaction information.

In operation S730, the block is stored in a blockchain. The blockchain includes at least one of a main chain blockchain of the main chain system and a parallel chain blockchain of a target parallel chain system, and the target parallel chain system includes at least one parallel chain system of the plurality of parallel chain systems.

According to the embodiments of the present disclosure, the main chain system includes a plurality of blockchain nodes, and the parallel chain system includes a plurality of blockchain nodes. The transaction information may be a transaction information stored in a transaction cache pool of each blockchain node. The transaction information in the transaction cache pools of different blockchains is consistent. The transaction information may include at least one of a quality information, an order logistics information and a supervision information.

According to the embodiments of the present disclosure, the transaction request transmitted by the user using the blockchain node is received, and the transaction information contained in the transaction request is broadcast in the supply chain management system, so that other blockchain nodes of the supply chain management system may receive the transaction information. A blockchain node with a ledger right for the transaction information is determined by using a consensus algorithm from the blockchain nodes that receive the transaction information. The blockchain node with the ledger right packages the transaction information to create a block for the transaction information. The block is broadcast so that other blockchain nodes in the supply chain management system may verify the block. When the verification result indicates success of the verification, the block is received and linked at a tail of the blockchain. After determining that all blockchain nodes receive the block, the storage of the transaction information in the blockchain is implemented. The blockchain may include at least one of the main chain blockchain of the main chain system and the parallel chain blockchain of the target parallel chain system.

According to the embodiments of the present disclosure, different parallel chain systems are information-isolation from each other, and the information sharing between different parallel chain systems is implemented based on the main chain system. Therefore, for each parallel chain system in the plurality of parallel chain systems, if the transaction information needs to be stored in the parallel chain blockchain of the parallel chain system and does not need to be shared with other parallel chain systems, the transaction information may be stored in the parallel chain blockchain of the parallel chain system and not stored in the main chain blockchain of the main chain system. In addition, in order to enable the main chain blockchain of the main chain system to store the full amount of transaction information, the transaction information may be stored in the parallel chain blockchain of the parallel chain system and the main chain blockchain of the main chain system.

If the transaction information needs to be stored in the parallel chain blockchain of the parallel chain system and needs to be shared with other parallel chain systems, the transaction information may be stored in the parallel chain blockchain of the parallel chain system and the main chain blockchain of the main chain system.

According to the embodiments of the present disclosure, by receiving the transaction request, processing the transaction information, creating a block for the transaction information and storing the block in the blockchain, the storage and minting of the transaction information of the supply chain management system created based on the blockchain may be implemented, and the reliability of the transaction information may be effectively ensured.

According to the embodiments of the present disclosure, the transaction information is an encrypted transaction information.

According to the embodiments of the present disclosure, in order to improve the security of the transaction information, the transaction information may be encrypted using a public key.

According to the embodiments of the present disclosure, the transaction information includes at least one of a quality information, an order logistics information, and a supervision information.

According to the embodiments of the disclosure, the supervision information includes at least one of an inspection project information, an inspector information, an ownership information, a project rectification information, a rectification result information, a signed project rectification information, an operator information, a project rectification report and a project evaluation information. The supervision information may provide a data support for a supplier quality evaluation, an inventory management and an order management.

According to the embodiments of the present disclosure, the quality information is stored in at least one of a main chain blockchain of the main chain system, a parallel chain blockchain of a supply chain parallel chain system included in the target parallel chain system, and a parallel chain blockchain of a warehouse management parallel chain system included in the target parallel chain system. The order logistics information is stored in at least one of the main chain blockchain of the main chain system and the parallel chain blockchain of the supply chain parallel chain system included in the target parallel chain system. The supervision information is stored in at least one of the main chain blockchain of the main chain system and a parallel chain blockchain of a supervision chain parallel chain system included in the target parallel chain system.

According to the embodiments of the present disclosure, the plurality of parallel chain systems may include a supply chain parallel chain system, a warehouse management parallel chain system, and a supervision parallel chain system. The quality information, the order logistics information and the supervision information may be stored in matching parallel chain blockchain according to the actual business needs.

According to the embodiments of the present disclosure, the quality information includes at least one of a quality information related to the demand object and a quality information related to the supply object. The quality information related to the demand object includes at least one of a device information, a production material information and a process parameter information related to the demand object. The quality information related to the supply object includes at least one of a device information, a production material information and a process parameter information related to the supply object.

According to the embodiments of the present disclosure, the device information includes at least one of a device life cycle information and an inventory information related to a device, and the device includes at least one of a production device and a detection device. The production material information includes at least one of an inventory information, a quality information and a demand information related to the production material.

According to the embodiments of the present disclosure, the device life cycle information includes at least one of an information related to a device warehousing stage, an information related to a device installation stage, an information related to a device fault handling stage, an information related to a device disassemble stage, and an information related to a device repair stage.

According to the embodiments of the present disclosure, the information related to the device warehousing stage includes at least one of a device identification corresponding to a radio frequency identification tag, a device model, an ownership identification, an accessory information and a device status information. The information related to the device installation stage includes at least one of an installation unit identification, an installer information, an installation time, an installed device information, an acceptance checker information and an acceptance check result information. The information related to the device fault handling stage includes at least one of a device fault information, a reporter information, a handler information and a handling information. The information related to the device disassemble stage includes at least one of a disassembled device information, a disassemble application unit information, a disassemble approval document information, and a disassemble receipt information. The information related to the device repair stage includes at least one of a repaired device information, a repair application unit information, a repair approval document information, and a repair receipt information.

According to the embodiments of the present disclosure, in the device warehousing stage, the device may be associated with a radio frequency identification tag, so that the device corresponds to the radio frequency identification tag. The device may be represented by a device identification. The device model, the ownership identification, the accessory information and the device status information may be associated with the device identification.

According to the embodiments of the present disclosure, the device fault information may include a fault device status information and a fault device cause information. The fault device status information is used to indicate that the fault device is in a fault status. The fault device cause information is used to indicate a cause of the device fault.

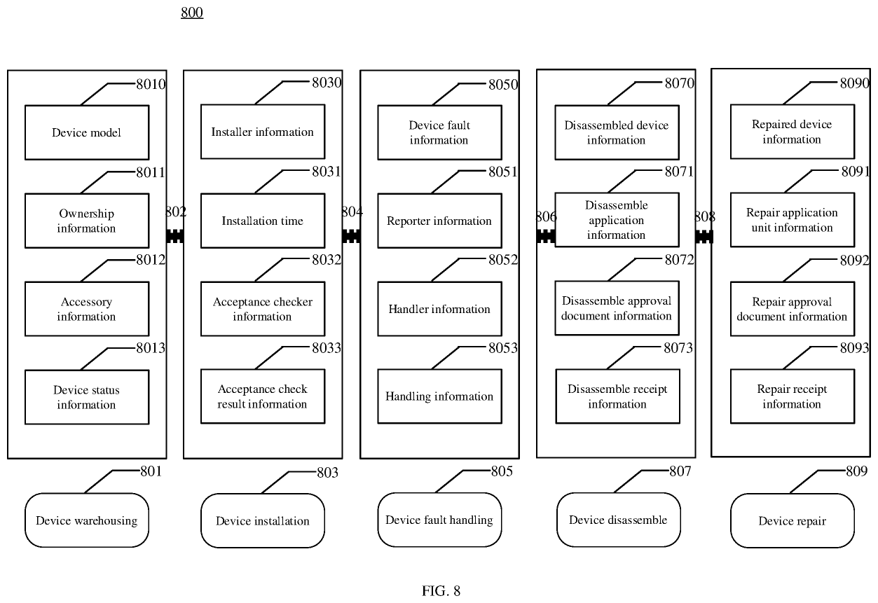

FIG. 8 schematically shows a schematic diagram of a process of storing the device life cycle information to a blockchain according to the embodiments of the present disclosure.

As shown in FIG. 8, in a process 800, the device life cycle information may be stored in the main chain blockchain of the main chain system, the parallel chain blockchain of the supply chain parallel chain system and the parallel chain blockchain of the warehouse management parallel chain system.

For a device warehousing 801 stage, the information related to the device warchousing 801 stage may be stored and minted. The information related to the device warehousing 801 stage includes a device model 8010, an ownership identification 8011, an accessory information 8012 and a device status information 8013.

For a device installation 803 stage, the information related to the device installation 803 stage may be stored and minted. The information related to the device installation 803 stage includes an installer information 8030, an installation time 8031, an acceptance checker information 8032 and an acceptance check result information 8033.

For a device fault processing 805 stage, the information related to the device fault processing 805 stage may be stored and minted. The information related to the device fault processing 805 stage includes a device fault information 8050, a reporter information 8051, a handler information 8052 and a handling information 8053.

For the device disassemble 807 stage, the information related to the device disassemble 807 stage may be stored and minted. The information related to the device disassemble 807 stage includes a disassembled device information 8070, a disassemble application unit information 8071, a disassemble approval document information 8072 and a disassemble receipt information 8073.

For the device repair 809 stage, the information related to the device repair 809 stage may be stored and minted. The information related to the device repair 809 includes a repaired device information 8090, a repair application unit information 8091, a repair approval document information 8092 and a repair receipt information 8093.

Between the block obtained by storing and minting the information related to the device warehousing 801 stage and the block obtained by storing and minting the information related to the device installation 803 stage is a block 802.

Between the block obtained by storing and minting the information related to the device installation 803 stage and the block obtained by storing and minting the information related to the device fault handling 805 stage is a block 804.

Between the block obtained by storing and minting the information related to the device fault handling 805 stage and the block obtained by storing and minting the information related to the device disassemble 807 stage is a block 806.

Between the block obtained by storing and minting the information related to the device disassemble 807 stage and the block obtained by storing and minting the information related to the device repair 809 stage is a block 808.

According to the embodiments of the present disclosure, by storing the device life cycle information in the blockchain, that is, by storing and minting the device life cycle information, the record and traceable query of the device life cycle information may be implemented.

According to the embodiments of the present disclosure, the order logistics information includes at least one of a part demand information related to the demand object, a supply object information, a part production information related to the supply object, a part order information, a transport object information and a delivery information.

According to the embodiments of the present disclosure, the part demand information may include at least one of a part identification of a part, a case number, and a number of parts. The part order information may include an order number.

According to the embodiments of the present disclosure, by storing the order logistics information in the blockchain, that is, by storing and minting the order logistics information, the storage and traceable query of the order logistics information may be implemented.

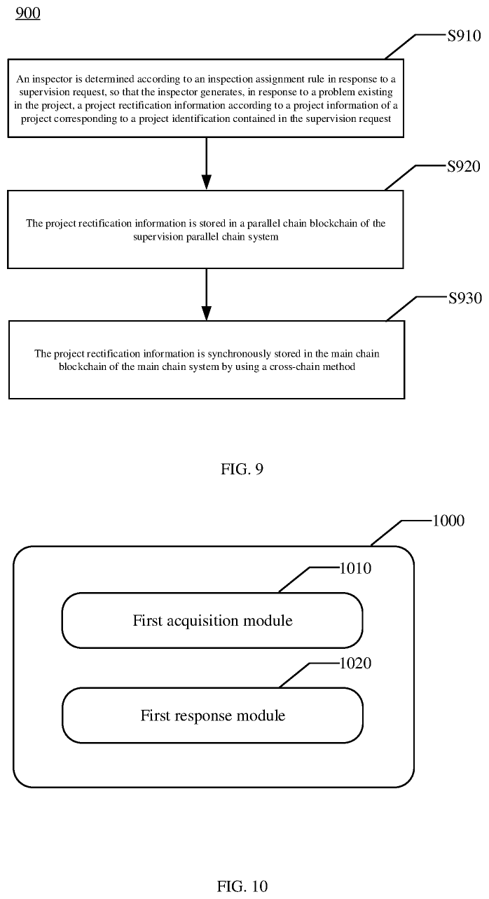

FIG. 9 schematically shows a flowchart of a method of processing an information according to another embodiment of the present disclosure.

According to the embodiments of the present disclosure, the method of processing the information may be applied to the supervision parallel chain system. The supervision parallel chain system is one of the plurality of parallel chain systems included in the supply chain management system. The supply chain management system further includes a main chain system connected to the plurality of parallel chain systems. Each of the parallel chain systems corresponds to a business scenario, and the information sharing between the plurality of parallel chain systems is implemented based on the main chain system. The supply chain management system is created according to the method of creating the blockchain-based supply chain management system described in the embodiments of the present disclosure.

As shown in FIG. 9, a method 900 includes operations S910 to S930.

In operation S910, an inspector is determined according to an inspection assignment rule in response to a supervision request, so that the inspector generates, in response to a problem existing in the project, a project rectification information according to a project information of a project corresponding to a project identification contained in the supervision request.

In operation S920, the project rectification information is stored in a parallel chain blockchain of the supervision parallel chain system.

In operation S930, the project rectification information is synchronously stored in the main chain blockchain of the main chain system by using a cross-chain method.

According to the embodiments of the present disclosure, the inspection assignment rule may refer to a rule on how to assign an inspector to a project. The supervision request may include a project identification, which is used to represent the project. The project rectification information may include an information on how to rectify the project. The cross-chain method may include a side chain method, a notary mechanism, a relay method, or a hash lock method.

According to the embodiments of the present disclosure, after the supervision request is received, the inspector of inspecting the project corresponding to the project identification may be determined according to the inspection assignment rule in response to the supervision request. When the inspector determines that a problem exists in the project, the project rectification information is generated according to the project information, and the project rectification information is stored in the parallel chain blockchain of the supervision parallel chain system. In order to share the project rectification information with other parallel chain systems, the project rectification information may be synchronously stored in the main chain blockchain of the main chain system by using the cross-chain method.

According to the embodiments of the present disclosure, an inspection task may be signed according to a private key of the inspector, so as to obtain an inspection task claim information. The inspection task claim information is stored in the parallel chain blockchain of the supervision parallel chain system, and is synchronously stored in the main chain blockchain of the main chain system by using the cross-chain method.

For example, the supervision parallel chain system acquires the supervision request, which contains the project identification of the project. The supervision parallel chain system determines the inspector according to the inspection assignment rule in response to the supervision request. When determining that a problem exists in the project corresponding to the project identification, the inspector may generate a project rectification information according to the project information of the project.

The blockchain node of the supervision parallel chain system corresponding to the inspector broadcasts the project rectification information in the supervision parallel chain system so that other blockchain nodes of the supervision parallel chain system may receive the project rectification information.

A blockchain node with a ledger right for the project rectification information is determined by using a consensus algorithm from the blockchain nodes that receive the project rectification information. The blockchain node with the ledger right packages the project rectification information to create a block for the project rectification information, and broadcasts the block, so that other blockchain nodes of the supervision parallel chain system verify the block. When the verification result indicates success of the verification, the block is received and linked at a tail of the parallel chain blockchain of the supervision parallel chain system.

After it is determined that all blockchain nodes of the supervision parallel chain system receive the block, the storage of the project rectification information in the parallel chain blockchain of the supervision parallel chain is implemented, and the project rectification information is synchronously stored in the main chain blockchain of the main chain system by using the cross-chain method. According to the embodiments of the present disclosure, the inspector is determined according to the inspection assignment rule in response to the supervision request, so that the inspector may generate, in response to determining that a problem exists in the project corresponding to the project identification contained in the supervision request, the project rectification information according to the project information of the project, store the project rectification information in the parallel chain blockchain of the supervision parallel chain system, and synchronously store the project rectification information in the main chain blockchain of the main chain system by using the cross-chain method, so that the storage and minting of the project rectification information may be implemented.

According to the embodiments of the present disclosure, generating the project rectification information according to the project information of the project may include the following operations.

A supervisory unit corresponding to the project is determined according to an ownership information. The project rectification information is generated according to the supervisory unit and the project information of the project.

According to the embodiments of the present disclosure, the ownership information may represent a relationship information between the project and the supervisory unit corresponding to the project. The project rectification information may include at least one of an issuing time, a rectification cause information and a supervisory unit.

According to the embodiments of the present disclosure, the method of processing the information described above may further include the following operations.

The project rectification information is transmitted to the supervisory unit, so that the supervisory unit processes the project according to the project rectification information to obtain a rectification result information. The rectification result information is stored in the parallel chain blockchain of the supervision parallel chain system. The rectification result information is synchronously stored in the main chain blockchain of the main chain system by using the cross-chain method.

According to the embodiments of the present disclosure, the rectification result information may include at least one of a rectification completion time, an on-site processing image information and a rectification success or failure information.

According to the embodiments of the present disclosure, processing the project according to the project rectification information to obtain the rectification result information may include the following operations.

An operator is determined according to an operator assignment rule, so that the operator processes the project according to the project rectification information to obtain the rectification result information.

According to the embodiments of the present disclosure, the operator assignment rule may refer to a rule on how to assign an operator for a project.

According to the embodiments of the present disclosure, the supervisory unit may determine the operator to rectify the project according to the project rectification information and the operator assignment rule, so that the operator may process the project according to the project rectification information and obtain the rectification result information.

According to the embodiments of the present disclosure, the rectification result information may be signed according to a private key of the operator so as to obtain a signed rectification result information.

According to the embodiments of the present disclosure, the method of processing the information described above may further include the following operations.

The project rectification information is signed according to a private key of a supervisor of the supervisory unit, so as to obtain the signed project rectification information. The signed project rectification information is stored in the parallel chain blockchain of the supervision parallel chain system. The signed project rectification information is synchronously stored in the main chain blockchain of the main chain system by using the cross-chain method.

According to the embodiments of the present disclosure, in order to ensure the security of the project rectification information, the project rectification information may be signed using the private key of the supervisor of the supervisory unit, so as to obtain the signed project rectification information, so that the operator may process the signed project rectification information and obtain the rectification result information.

According to the embodiments of the present disclosure, the method of processing the information described above may further include the following operations.

An operator assignment information corresponding to the operator is generated. The operator assignment information is stored in the parallel chain blockchain of the supervision parallel chain system. The operator assignment information is synchronously stored in the main chain blockchain of the main chain system by using the cross-chain method.

According to the embodiments of the present disclosure, the operator assignment information may be stored and minted.

According to the embodiments of the present disclosure, the method of processing the information described above may further include the following operations.

A project rectification report for the project is generated in response to a re-inspection result indicating success of a re-inspection of the rectification result information by the supervisor. The re-inspection result and the project rectification report are stored in the parallel chain blockchain of the supervision parallel chain system. The re-inspection result and the project rectification report are synchronously stored in the main chain blockchain of the main chain system by using the cross-chain method.

According to the embodiments of the present disclosure, the project rectification report may include an information related to the re-inspection operation and an information to evaluate a rectification effect. The re-inspection result may include success or fail. The supervisor may re-inspect the rectification result information to obtain the re-inspection result, and generate the project rectification report for the project when the re-inspection result indicates success of the re-inspection.

According to the embodiments of the present disclosure, the method of processing the information described above may further include the following operations.

A relevant operation of the supervisory unit in processing the project may be evaluated to obtain a project evaluation information. The project evaluation information is stored in a parallel chain of the supervision parallel chain system. The project evaluation information is synchronously stored in the main chain blockchain of the main chain system by using the cross-chain method.

According to the embodiments of the present disclosure, the project evaluation information may include an information to evaluate whether or not the relevant operation of the supervisory unit in processing the project is correct and timely.

According to the embodiments of the present disclosure, storing and minting the project evaluation information may prove a credibility of the supervisory unit and facilitate a rational allocation of resources.

FIG. 10 schematically shows a block diagram of an apparatus of creating a blockchain-based supply chain management system according to the embodiments of the present disclosure.

As shown in FIG. 10, an apparatus 1000 of creating a blockchain-based supply chain management system includes a first acquisition module 1010 and a first response module 1020.

The first acquisition module 1010 is used to acquire a creation request for creating a supply chain management system. The creation request contains a business information related to creating the supply chain management system;

The first response module 1020 is used to create the supply chain management system according to the business information and the blockchain basic architecture, in response to the creation request. The blockchain basic architecture includes an interface layer, a management layer, a core layer and a base layer, and the supply chain management system includes a main chain system and a plurality of parallel chain systems connected to the main chain system, each of the parallel chain systems corresponds to a business scenario, and an information sharing between the plurality of parallel chain systems is implemented based on the main chain system.

According to the embodiments of the present disclosure, the first response module 1020 may include a determination unit and a creation unit.

The determination unit is used to determine a configuration information according to the business information. The configuration information includes a node information, a smart contract information and an authority information.

The creation unit is used to create the supply chain management system according to the configuration information and the blockchain basic architecture.

According to the embodiments of the present disclosure, each parallel chain system is connected to the main chain system through a remote procedure call protocol interface.

According to the embodiments of the present disclosure, the plurality of parallel chain systems include a supply chain parallel chain system, a warehouse management parallel chain system, and a supervision parallel chain system.

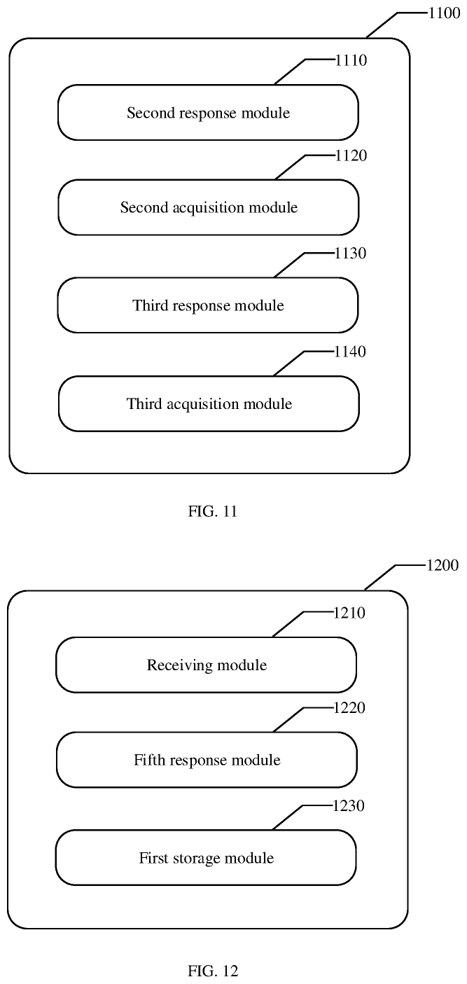

FIG. 11 schematically shows a block diagram of an apparatus of processing an information according to an embodiment of the present disclosure.

According to the embodiments of the present disclosure, the apparatus of processing the information may be arranged in a supply chain management system. The supply chain management system may include a main chain system and a plurality of parallel chain systems connected to the main chain system, cach of the parallel chain systems corresponds to a business scenario, and an information sharing between the plurality of parallel chain systems is implemented based on the main chain system. The supply chain management system is created according to the method of creating the blockchain-based supply chain management system described in the embodiments of the present disclosure.

As shown in FIG. 11, an apparatus 1100 of processing an information includes a second response module 1110, a second acquisition module 1120, a third response module 1130, and a third acquisition module 1140.

The second response module 1100 is used to verify, in response to an authority verification request, a user information contained in the authority verification request. The authority verification request requests to verify whether a user corresponding to the user information has an information query authority or not.

The second acquisition module 1120 is used to acquire an information query request in response to a verification result of the user corresponding to the user information having the information query authority. The information query request contains an information identification

The third response module 1130 is used to determine, in response to the information query request, a blockchain storing a transaction information corresponding to the information identification. The blockchain includes at least one of a main chain blockchain of the main chain system and a parallel chain blockchain of the parallel chain systems.

The third acquisition module 1140 is used to acquire the transaction information corresponding to the information identification from the blockchain storing the transaction information.

According to the embodiments of the present disclosure, the third acquisition module 1140 may include a first acquisition unit, a second acquisition unit, and a third acquisition unit.

The first acquisition unit is used to acquire the transaction information corresponding to the information identification from the main chain blockchain, in response to determining that a blockchain system the blockchain storing the transaction information corresponding to the information identification belongs to includes at least one of a first parallel chain system and the main chain system and that a blockchain system corresponding to a blockchain node for generating the authority verification request is a second parallel chain system. The first parallel chain system and the second parallel chain system are parallel chain systems in the plurality of parallel chain systems.

The second acquisition unit is used to acquire the transaction information from the blockchain storing the transaction information corresponding to the information identification, in response to determining that the blockchain system the blockchain storing the transaction information corresponding to the information identification belongs to includes at least one of the first parallel chain system and the main chain system and that the blockchain system corresponding to the blockchain node for generating the authority verification request is the first parallel chain system.

The third acquisition unit is used to acquire the transaction information corresponding to the information identification from the main chain blockchain, in response to determining that the blockchain system the blockchain storing the transaction information corresponding to the information identification belongs to is the main chain system and that the blockchain system corresponding to the blockchain node for generating the authority verification request is the main chain system.

According to the embodiments of the present disclosure, the user includes a supply object, and the transaction information includes an inventory information and a demand information related to a demand object.

The apparatus 1100 of processing the information may further include a first transmitting module.

The first transmitting module is used to transmit the transaction information to the user so that the user may prepare goods according to the transaction information.

According to the embodiments of the present disclosure, the user includes a demand object.

The apparatus 1100 of processing the information may further include a fourth response module.

The fourth response module is used to call a purchase-related smart contract in response to a purchase request from the demand object, so as to perform a purchase operation between the demand object and the supply object contained in the purchase request.

According to the embodiments of the present disclosure, the purchase-related smart contract includes a purchase contract and a payment contract.

The fourth response module may include a fourth acquisition unit, a response unit, a generation unit, a calling unit and a purchase payment unit.

The fourth acquisition unit is used to acquire the purchase request from the demand object. The purchase request contains the demand object, the supply object and the purchase information.

The response unit is used to call the purchase contract in response to the purchase request.

The generation unit is used to generate a purchase event for the purchase information by using a purchase contract.

The calling unit is used to call the payment contract when acquiring the purchase confirmation information for the purchase event from the supply object.

The purchase payment unit is used to perform the purchase payment by using the payment contract.

FIG. 12 schematically shows a block diagram of an apparatus of storing an information according to an embodiment of the present disclosure.

According to the embodiments of the present disclosure, the apparatus of storing the information may be arranged in a supply chain management system. The supply chain management system may include a main chain system and a plurality of parallel chain systems connected to the main chain system, each of the parallel chain systems corresponds to a business scenario, and an information sharing between the plurality of parallel chain systems is implemented based on the main chain system. The supply chain management system is created according to the method of creating the blockchain-based supply chain management system described in the embodiments of the present disclosure.

As shown in FIG. 12, an apparatus 1200 of storing an information 1200 may include a receiving module 1210 , a fifth response module 1220, and a first storage module 1230.

The receiving module 1210 is used to receive a transaction request. The transaction request contains a transaction information.

The fifth response module 1220 is used to process the transaction information in response to the transaction request, so as to create a block for the transaction information.

The first storage module 1230 is used to store the block in a blockchain. The blockchain includes at least one of a main chain blockchain of the main chain system and a parallel chain blockchain of a target parallel chain system, and the target parallel chain system includes at least one parallel chain system of the plurality of parallel chain systems.

According to the embodiments of the present disclosure, the transaction information is an encrypted transaction information.

According to the embodiments of the present disclosure, the transaction information includes at least one of a quality information, an order logistics information, and a supervision information.

According to the embodiments of the present disclosure, the quality information is stored in at least one of a main chain blockchain of the main chain system, a parallel chain blockchain of a supply chain parallel chain system included in the target parallel chain system, and a parallel chain blockchain of a warehouse management parallel chain system included in the target parallel chain system;

The order logistics information is stored in at least one of the main chain blockchain of the main chain system and the parallel chain blockchain of the supply chain parallel chain system included in the target parallel chain system.

The supervision information is stored in at least one of the main chain blockchain of the main chain system and the parallel chain blockchain of the supervision chain parallel chain system included in the target parallel chain system.

According to the embodiments of the present disclosure, the quality information includes at least one of a quality information related to the demand object and a quality information related to the supply object.

The quality information related to the demand object includes at least one of a device information, a production material information and a process parameter information related to the demand object.

The quality information related to the supply object includes at least one of a device information, a production material information and a process parameter information related to the supply object.

According to the embodiments of the present disclosure, the device information includes at least one of a device life cycle information and an inventory information related to a device, and the device includes at least one of a production device and a detection device.

The production material information includes at least one of an inventory information, a quality information and a demand information related to the production material.

According to the embodiments of the present disclosure, the device life cycle information includes at least one of an information related to a device warehousing stage, an information related to a device installation stage, an information related to a device fault handling stage, an information related to a device disassemble stage, and an information related to a device repair stage.

According to the embodiments of the present disclosure, the information related to the device warehousing stage includes at least one of a device identification corresponding to a radio frequency identification tag, a device model, an ownership identification, an accessory information and a device status information.

The information related to the device installation stage includes at least one of an installation unit identification, an installer information, an installation time, an installed device information, an acceptance checker information and an acceptance check result information;

The information related to the device fault handling stage includes at least one of a device fault information, a reporter information, a handler information and a handling information;

The information related to the device disassemble stage includes at least one of a disassembled device information, a disassemble application unit information, a disassemble approval document information, and a disassemble receipt information.

The information related to the device repair stage includes at least one of a repaired device information, a repair application unit information, a repair approval document information, and a repair receipt information.

According to the embodiments of the present disclosure, the order logistics information includes at least one of a part demand information related to a demand object, a supply object information, a part production information related to the supply object, a part order information, a transport object information, and a delivery information.

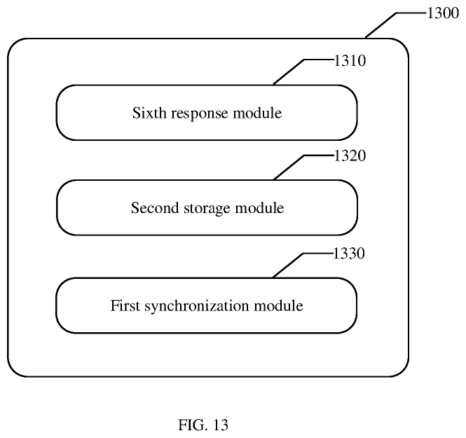

FIG. 13 schematically shows a block diagram of an apparatus of processing an information according to another embodiment of the present disclosure.

According to the embodiments of the present disclosure, the apparatus of processing the information may be arranged in a supervision parallel chain system. The supervision parallel chain system is one of the plurality of parallel chain systems included in the supply chain management system. The supply chain management system further includes a main chain system connected to the plurality of parallel chain systems. Each of the parallel chain systems corresponds to a business scenario, and the information sharing between the plurality of parallel chain systems is implemented based on the main chain system. The supply chain management system is created according to the method of creating the blockchain-based supply chain management system described in the embodiments of the present disclosure.

As shown in FIG. 13, an apparatus 1300 of processing an information may include a sixth response module 1310, a second storage module 1320 and a first synchronization module 1330.

The sixth response module 1310 is used to determine an inspector according to an inspection distribution rule in response to a supervision request, so that the inspector generates, in response to determining that a problem exists in a project corresponding to a project identification contained in the supervision request, a project rectification information according to a project information of the project.

The second storage module 1320 is used to store the project rectification information in a parallel chain blockchain of the supervision parallel chain system.

The first synchronization module 1330 is used to synchronously store the project rectification information in a main chain blockchain of the main chain system by using a cross-chain method.

According to the embodiments of the present disclosure, generating the project rectification information according to the project information of the project may include the following operations.

A supervisory unit corresponding to the project is determined according to an ownership information. The project rectification information is generated according to the supervisory unit and the project information of the project.

According to the embodiments of the present disclosure, the apparatus 1300 of processing the information may further include a second transmitting module, a third storage module, and a second synchronization module.

The second transmitting module is used to transmit the project rectification information to the supervisory unit, so that the supervisory unit processes the project according to the project rectification information, so as to obtain a rectification result information.

The third storage module is used to store the rectification result information in the parallel chain blockchain of the supervision parallel chain system.

The second synchronization module is used to synchronously store the rectification result information in the main chain blockchain of the main chain system by using the cross-chain method.

According to the embodiments of the present disclosure, processing the project according to the project rectification information so as to obtain the rectification result information may include the following operations.

An operator is determined according to an operator assignment rule, so that the operator processes the project according to the project rectification information, so as to obtain the rectification result information.

According to the embodiments of the present disclosure, the apparatus 1300 of processing the information may further include a signing module, a fourth storage module, and a third synchronization module.

The signing module is used to sign the project rectification information according to a private key of a supervisor of the supervisory unit, so as to obtain the signed project rectification information.

The fourth storage module is used to store the signed project rectification information in the parallel chain blockchain of the supervision parallel chain system.

The third synchronization module is used to synchronously store the signed project rectification information in the main chain blockchain of the main chain system by using the cross-chain method.

According to the embodiments of the present disclosure, the apparatus 1300 of processing the information may further include a first generation module, a fifth storage module, and a fourth synchronization module.

The first generation module is used to generate an operator assignment information corresponding to the operator.

The fifth storage module is used to store the operator assignment information in the parallel chain blockchain of the supervision parallel chain system.

The fourth synchronization module is used to synchronously store the operator assignment information in the main chain blockchain of the main chain system by using the cross-chain method.

According to the embodiments of the present disclosure, the apparatus 1300 of processing the information may further include a second generation module, a sixth storage module, and a fifth synchronization module.

The second generation module is used to generate a project rectification report for the project in response to a re-inspection result indicating success of a re-inspection of the rectification result information by the supervisor.

The sixth storage module is used to store the re-inspection result and the project rectification report in the parallel chain blockchain of the supervision parallel chain system.

The fifth synchronization module is used to synchronously store the re-inspection result and the project rectification report in the main chain blockchain of the main chain system by using the cross-chain method.

According to the embodiments of the present disclosure, the apparatus 1300 of processing the information may further include an evaluation module, a seventh storage module, and a sixth synchronization module.

The evaluation module is used to evaluate a relevant operation of the supervisory unit in processing the project, so as to obtain a project evaluation information.

The seventh storage module is used to store the project evaluation information in a parallel chain of the supervision parallel chain system.

The sixth synchronization module is used to synchronously store the project evaluation information in the main chain blockchain of the main chain system by using the cross-chain method.

Any number of the modules, sub-modules, units and subunits according to the embodiments of the present disclosure, or at least part of the functions of any number of them may be implemented in one module. Any one or more of the modules, sub-modules, units and subunits according to the embodiments of the present disclosure may be split into multiple modules for implementation. Any one or more of the modules, sub-modules, units and subunits according to the embodiments of the present disclosure may be implemented at least partially as a hardware circuit, such as a field programmable gate array (FPGA), a programmable logic array (PLA), a system on a chip, a system on a substrate, a system on a package, an Application Specific Integrated Circuit (ASIC), or may be implemented by hardware or firmware in any other reasonable way that integrates or encapsulates the circuit, or may be implemented by any one of the three implementation modes of software, hardware and firmware or an appropriate combination thereof. Alternatively, one or more of the modules, sub-modules, units and subunits according to the embodiments of the present disclosure may be at least partially implemented as a computer program module that, when executed, may perform the corresponding functions.

For example, any plurality of the first acquisition module 1010 and the first response module 1020, the second response module 1110, the second acquisition module 1120, the third response module 1130 and the third acquisition module 1140, the receiving module 1210, the fifth response module 1220 and the first storage module 1230, the sixth response module 1310, the second storage module 1320 and the first synchronization module 1330 may be integrated into one module/unit/subunit for implementation, or any one thereof may be split into a plurality of modules/units/subunits. Alternatively, at least part of functions of one or more of these modules/units/subunits may be combined with at least part of functions of other modules/units/subunits and implemented in one module/unit/subunit. According to the embodiments of the present disclosure, at least one of the first acquisition module 1010 and the first response module 1020, the second response module 1110, the second acquisition module 1120, the third response module 1130 and the third acquisition module 1140, the receiving module 1210. the fifth response module 1220 and the first storage module 1230, the sixth response module 1310, the second storage module 1320 and the first synchronization module 1330 may be implemented at least partially as a hardware circuit, such as a field programmable gate array (FPGA), a programmable logic array (PLA), a system on a chip, a system on a substrate, a system on a package, an Application Specific Integrated Circuit (ASIC), or may be implemented by hardware or firmware in any other reasonable way that integrates or encapsulates the circuit, or may be implemented by any one of the three implementation modes of software, hardware and firmware or an appropriate combination thereof. Alternatively, at least one of the first acquisition module 1010 and the first response module 1020, the second response module 1110, the second acquisition module 1120, the third response module 1130 and the third acquisition module 1140, the receiving module 1210, the fifth response module 1220 and the first storage module 1230, the sixth response module 1310, the second storage module 1320 and the first synchronization module 1330 may be at least partially implemented as a computer program module that, when executed, may perform the corresponding functions.

It should be noted that the apparatus of creating the blockchain-based supply chain management system, the apparatus of processing the information and the apparatus of storing the information in the embodiments of the present disclosure correspond to the method of creating the blockchain-based supply chain management system, the method of processing the information and the method of storing the information in the embodiments of the present disclosure. For the description of the apparatus of creating the blockchain-based supply chain management system, the apparatus of processing the information and the apparatus of storing the information, reference may be made to the method of creating the blockchain-based supply chain management system, the method of processing the information and the method of storing the information, and details are not be repeated here.

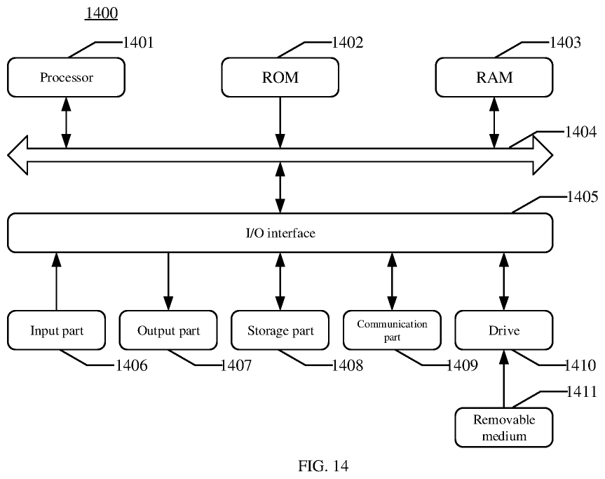

FIG. 14 schematically shows a block diagram of an electronic device suitable for implementing the method described above according to the embodiments of the present disclosure. The electronic device shown in FIG. 14 is merely an example, and should not bring any limitation to the function and scope of use of the embodiments of the present disclosure.

As shown in FIG. 14, an electronic device 1400 according to the embodiments of the present disclosure includes a processor 1401 that may execute various appropriate actions and processing according to a program stored in a read only memory (ROM) 1402 or a program loaded from a storage part 1408 into a random access memory (RAM) 1403. The processor 1401 may, for example, include a general-purpose microprocessor (for example, CPU), an instruction set processor and/or a related chipset and/or a special-purpose microprocessor (for example, an application specific integrated circuit (ASIC)), and the like. The processor 1401 may further include an on-board memory for a caching purpose. The processor 1401 may include a single processing unit or a plurality of processing units for executing different actions of the method flow according to the embodiments of the present disclosure.

Various programs and data required for an operation of the system 1400 are stored in the RAM 1403. The processor 1401, the ROM 1402 and the RAM 1403 are connected to each other through a bus 1404. The processor 1401 executes various operations of the method flow according to the embodiments of the present disclosure by executing the program in the ROM 1402 and/or the RAM 1403. It should be noted that the program may also be stored in one or more memories other than the ROM 1402 and the RAM 1403. The processor 1401 may also execute various operations of the method flow according to the embodiments of the present disclosure by executing the program stored in the one or more memories.

According to the embodiments of the present disclosure, the electronic device 1400 may further include an input/output (I/O) interface 1405 that is also connected to the bus 1404. The electronic device 1400 may further include one or more of the following components connected to the I/O interface 1405: an input part 1406 including a keyboard, a mouse, etc.; an output part 807 including a cathode ray tube (CRT), a liquid crystal display (LCD), etc. and a speaker, etc.; a storage part 1408 including a hard disk, etc.; and a communication part 1409 including a network interface card such as a LAN card, a modem, and the like. The communication part 1409 performs communication processing via a network such as the Internet. A drive 1410 is also connected to the I/O interface 1405 as required. A removable medium 1411, such as a magnetic disk, an optical disk, a magneto-optical disk, a semiconductor memory, etc., is installed on the drive 1410 as required, so that the computer program read therefrom is installed into the storage part 1408 as needed.

The method flow according to the embodiments of the present disclosure may be implemented as a computer software program. For example, the embodiments of the present disclosure include a computer program product containing a computer program carried on a computer-readable storage medium. The computer program contains a program code for execution of the method shown in the flowchart. In such an embodiment, the computer program may be downloaded and installed from the network through the communication part 1409, and/or installed from the removable medium 1411. When the computer program is executed by the processor 1401, the above-mentioned functions defined in the system of the embodiments of the present disclosure may be performed. According to the embodiments of the present disclosure, the above-described system, apparatus, device, module, unit, etc. may be implemented by a computer program module.

The present disclosure further provides a computer-readable storage medium, which may be included in the apparatus/device/system described in the above embodiments; or exist alone without being assembled into the apparatus/device/system. The above-mentioned computer-readable storage medium may carry one or more programs that when executed, implement the method according to the embodiments of the present disclosure.

According to the embodiments of the present disclosure, the computer-readable storage medium may be a non-transitory computer-readable storage medium that, for example, may include but is not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores programs that may be used by or in combination with an instruction execution system, apparatus or device.

For example, according to the embodiments of the present disclosure, the computer-readable storage medium may include the ROM 1402 and/or the RAM 1403 described above and/or one or more memories other than the ROM 1402 and the RAM 1403.

The embodiments of the present disclosure further include a computer program product, which contains a computer program. The computer program contains program code for performing the method provided by the embodiments of the present disclosure. When the computer program product runs on an electronic device, the program code causes the electronic device to implement the method of creating the blockchain-based supply management system, the method of processing the information and the method of storing the information provided by the embodiments of the present disclosure.

When the computer program is executed by the processor 1401, the above-mentioned functions defined in the system/apparatus of the embodiments of the present disclosure are performed. According to the embodiments of the present disclosure, the above-described systems, apparatuses, modules, units, etc. may be implemented by computer program modules.

In an embodiment, the computer program may rely on a tangible storage medium such as an optical storage device and a magnetic storage device. In another embodiment, the computer program may also be transmitted and distributed in the form of signals on a network medium, downloaded and installed through the communication part 1409, and/or installed from the removable medium 1411. The program code contained in the computer program may be transmitted by any suitable medium, including but not limited to a wireless one, a wired one, or any suitable combination of the above.

According to the embodiments of the present disclosure, the program code for executing the computer programs provided by the embodiments of the present disclosure may be written in any combination of one or more programming languages. In particular, these computing programs may be implemented using high-level procedures and/or object-oriented programming languages, and/or assembly/machine languages. Programming languages include, but are not limited to, Java, C++, Python, “C” language or similar programming languages. The program code may be completely executed on the user computing device, partially executed on the user device, partially executed on the remote computing device, or completely executed on the remote computing device or server. In a case of involving a remote computing device, the remote computing device may be connected to a user computing device through any kind of network, including a local area network (LAN) or a wide area networks (WAN), or may be connected to an external computing device (e.g., through the Internet using an Internet service provider).

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions. Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

The embodiments of the present disclosure have been described above. However, these embodiments are for illustrative purposes only, and are not intended to limit the scope of the present disclosure. Although the embodiments have been described separately above, this does not mean that measures in the respective embodiments may not be used in combination advantageously. The scope of the present disclosure is defined by the appended claims and their equivalents. Without departing from the scope of the present disclosure, those skilled in the art may make various substitutions and modifications, and these substitutions and modifications should all fall within the scope of the present disclosure.

1. A method of creating a blockchain-based supply chain management system, comprising:
acquiring a creation request for creating the supply chain management system, wherein the creation request contains a business information related to creating the supply chain management system; and
creating the supply chain management system according to the business information and a blockchain basic architecture, in response to the creation request,
wherein, the blockchain basic architecture comprises an interface layer, a management layer, a core layer and a base layer, the supply chain management system comprises a main chain system and a plurality of parallel chain systems connected to the main chain system, each of the parallel chain systems corresponds to a business scenario, and an information sharing between the plurality of parallel chain systems is achieved based on the main chain system.

2. The method of claim 1, wherein the creating the supply chain management system according to the business information and a blockchain basic architecture comprises:
determining a configuration information according to the business information, wherein the configuration information comprises a node information, a smart contract information and an authority information; and
creating the supply chain management system according to the configuration information and the blockchain basic architecture.

3. The method of claim 1, wherein a complexity of a smart contract running on the parallel chain systems is greater than a complexity of a smart contract running on the main chain system.

4. The method of claim 1, wherein each of the parallel chain systems is connected to the main chain system through a remote procedure call protocol interface.

5. The method of claim 1, wherein the plurality of parallel chain systems comprise a supply chain parallel chain system, a warehouse management parallel chain system, and a supervision parallel chain system.

6. A method of processing an information, applied to a supply chain management system, wherein the supply chain management system comprises a main chain system and a plurality of parallel chain systems connected to the main chain system, each of the parallel chain systems corresponds to a business scenario, and an information sharing between the plurality of parallel chain systems is achieved based on the main chain system; and
the method comprises:
verifying, in response to an authority verification request, a user information contained in the authority verification request, wherein the authority verification request requests to verify whether a user corresponding to the user information has an information query authority or not;
acquiring an information query request in response to a verification result of the user corresponding to the user information having the information query authority, wherein the information query request contains an information identification;
determining, in response to the information query request, a blockchain storing a transaction information corresponding to the information identification, wherein the blockchain comprises at least one of a main chain blockchain of the main chain system and a parallel chain blockchain of the parallel chain systems; and
acquiring the transaction information from the blockchain storing the transaction information corresponding to the information identification.

7. The method of claim 6, wherein the acquiring the transaction information from the blockchain storing the transaction information corresponding to the information identification comprises:
acquiring the transaction information corresponding to the information identification from the main chain blockchain, in response to determining that a blockchain system the blockchain storing the transaction information corresponding to the information identification belongs to comprises at least one of a first parallel chain system and the main chain system and that a blockchain system corresponding to a blockchain node for generating the authority verification request is a second parallel chain system, wherein the first parallel chain system and the second parallel chain system are parallel chain systems in the plurality of parallel chain systems; or
acquiring the transaction information from the blockchain storing the transaction information corresponding to the information identification, in response to determining that the blockchain system the blockchain storing the transaction information corresponding to the information identification belongs to comprises at least one of the first parallel chain system and the main chain system and that the blockchain system corresponding to the blockchain node for generating the authority verification request is the first parallel chain system; or
acquiring the transaction information corresponding to the information identification from the main chain blockchain, in response to determining that the blockchain system the blockchain storing the transaction information corresponding to the information identification belongs to is the main chain system and that the blockchain system corresponding to the blockchain node for generating the authority verification request is the main chain system.

8. (canceled)

9. The method of claim 6 or 7, wherein the user comprises a demand object; and
the method further comprises:
calling a purchase-related smart contract in response to a purchase request from the demand object, so as to perform a purchase operation between the demand object and a supply object contained in the purchase request.

10. The method of claim 9, wherein the purchase-related smart contract comprises a purchase contract and a payment contract; and
wherein the calling a purchase-related smart contract in response to a purchase request from the demand object, so as to perform a purchase operation between the demand object and a supply object contained in the purchase request comprises:
acquiring the purchase request from the demand object, wherein the purchase request contains the demand object, the supply object and a purchase information;
calling the purchase contract in response to the purchase request;
generating a purchase event for the purchase information by using the purchase contract;
calling the payment contract in response to acquiring a purchase confirmation information for the purchase event from the supply object; and
performing a purchase payment by using the payment contract.

11. The method of claim 7, wherein the transaction information comprises a supervision information; and
wherein the acquiring the transaction information from the blockchain storing the transaction information corresponding to the information identification, in response to determining that the blockchain system the blockchain storing the transaction information corresponding to the information identification belongs to comprises at least one of the first parallel chain system and the main chain system and that the blockchain system corresponding to the blockchain node for generating the authority verification request is the first parallel chain system comprises:
acquiring the supervision information from a parallel chain blockchain of a supervision parallel chain system, in response to determining that the blockchain system the blockchain storing the transaction information corresponding to the information identification belongs to is the supervision parallel chain system and the blockchain system corresponding to the blockchain node for generating the authority verification request is the supervision parallel chain system.

12. The method of claim 7, wherein the transaction information comprises an order information; and
wherein the acquiring the transaction information corresponding to the information identification from the main chain blockchain, in response to determining that a blockchain system the blockchain storing the transaction information corresponding to the information identification belongs to comprises at least one of a first parallel chain system and the main chain system and that a blockchain system corresponding to a blockchain node for generating the authority verification request is a second parallel chain system comprises:
acquiring the order information from a main chain blockchain of the main chain system, in response to determining that the blockchain system the blockchain storing the transaction information corresponding to the information identification belongs to is a supply chain parallel chain system and the blockchain system corresponding to the blockchain node for generating the authority verification request is a supervision parallel chain system.

13. A method of storing an information, applied to a supply chain management system, wherein the supply chain management system comprises a main chain system and a plurality of parallel chain systems connected to the main chain system, each of the parallel chain systems corresponds to a business scenario, and an information sharing between the plurality of parallel chain systems is achieved based on the main chain system; and
the method comprises:
receiving a transaction request, wherein the transaction request contains a transaction information;
processing the transaction information to create a block for the transaction information, in response to the transaction request; and
storing the block in a blockchain, wherein the blockchain comprises at least one of a main chain blockchain of the main chain system and a parallel chain blockchain of a target parallel chain system, and the target parallel chain system comprises at least one parallel chain system of the plurality of parallel chain systems.

14. (canceled)

15. The method of claim 13, wherein the transaction information comprises at least one of a quality information, an order logistics information and a supervision information, wherein the quality information is stored in at least one of: the main chain blockchain of the main chain system, a parallel chain blockchain of a supply chain parallel chain system comprised in the target parallel chain system, or a parallel chain blockchain of a warehouse management parallel chain system comprised in the target parallel chain system;
wherein the order logistics information is stored in at least one of: the main chain blockchain of the main chain system, or the parallel chain blockchain of the supply chain parallel chain system comprised in the target parallel chain system; and
wherein the supervision information is stored in at least one of: the main chain blockchain of the main chain system, or a parallel chain blockchain of a supervision chain parallel chain system comprised in the target parallel chain system.

16-21. (Canceled)

22. A method of processing an information, applied to a supervision parallel chain system, wherein the supervision parallel chain system is one of a plurality of parallel chain systems in a supply chain management system, the supply chain management system further comprises a main chain system connected to the plurality of parallel chain systems, each of the parallel chain systems corresponds to a business scenario, and an information sharing between the plurality of parallel chain systems is achieved based on the main chain system; and
the method comprises:
determining an inspector according to an inspection assignment rule in response to a supervision request, so that the inspector generates, in response to determining that a problem exists in a project corresponding to a project identification contained in the supervision request, a project rectification information according to a project information of the project;
storing the project rectification information in a parallel chain blockchain of the supervision parallel chain system; and
synchronously storing the project rectification information in a main chain blockchain of the main chain system by using a cross-chain method.

23. The method of claim 22, wherein the generating a project rectification information according to a project information of the project comprises:
determining a supervisory unit corresponding to the project according to an ownership information;
generating the project rectification information according to the supervisory unit and the project information of the project;
transmitting the project rectification information to the supervisory unit, so that the supervisory unit processes the project according to the project rectification information to obtain a rectification result information;
storing the rectification result information in the parallel chain blockchain of the supervision parallel chain system; and
synchronously storing the rectification result information in the main chain blockchain of the main chain system by using the cross-chain method.

24-25. (canceled)

26. The method of claim 23, further comprising:
signing the project rectification information according to a private key of a supervisor of the supervisory unit, so as to obtain a signed project rectification information;
storing the signed project rectification information in the parallel chain blockchain of the supervision parallel chain system; and
synchronously storing the signed project rectification information in the main chain blockchain of the main chain system by using the cross-chain method.

27. The method of claim 24, further comprising:
generating an operator assignment information corresponding to the operator;
storing the operator assignment information in the parallel chain blockchain of the supervision parallel chain system; and
synchronously storing the operator assignment information in the main chain blockchain of the main chain system by using the cross-chain method.

28. The method of claim 27, further comprising:
generating a project rectification report for the project in response to a re-inspection result indicating success of a re-inspection of the rectification result information by the supervisor;
storing the re-inspection result and the project rectification report in the parallel chain blockchain of the supervision parallel chain system; and
synchronously storing the re-inspection result and the project rectification report in the main chain blockchain of the main chain system by using the cross-chain method.

29-33. (canceled)

34. An electronic device, comprising:
one or more processors; and
a memory for storing one or more programs, wherein the one or more programs, when executed by the one or more processors, cause the one or more processors to implement the method of claim 1.

35. A computer-readable medium having executable instructions stored thereon, wherein the instructions, when executed by a processor, cause the processor to implement the method of claim 1.

36. (canceled)
